(19) United States
(12) Patent Application Publication
(10) Pub. No.: US 2006/0099335 A1
(43) Pub. Date: May 11, 2006

(54) Spray coating apparatus and spray coating method

(75) Inventors: Tomohiko Sakai, Tokyo (JP); Kiyokazu Tanahashi, Tokyo (JP); Kiyoshi Endo, Kaisei-machi (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Photo Imaging, Inc., Tokyo (JP)

(21) Appl. No.: 11/265,564

(22) Filed: Nov. 2, 2005

(30) Foreign Application Priority Data
Nov. 8, 2004 (JP) JP2004-323302

(51) Int. Cl. B05D 1/02; B05C 5/00; B05C 11/00; B05D 3/12

(52) U.S. Cl. 427/171; 427/421.1; 118/300; 118/672; 427/424

(57) ABSTRACT

A spray coating apparatus is provided with a conveying apparatus that conveys the object to be coated in the conveyance direction, a spraying head that is placed in a direction that intersects said conveyance direction and that coats the coating solution onto the object to be coated, and a tensile force applying device that applies a prescribed tensile force to the object to be coated in the coating section by said spraying head, and said tensile force applying device maintains the variation of the average positions of the surface of the object to be coated in said coating section from the tip of said spray head, between in the uncoated condition and during coating to be within 0.5% relative to the width of the object to be coated at right angles to said conveyance direction.

This application is based on Japanese Patent Application No. 2004-323302 filed on Nov. 8, 2004 in Japanese Patent Office, the entire content of which is hereby incorporated by reference.

### BACKGROUND OF THE INVENTION

The present invention relates to spray coating apparatus and spray coating method which can exhibit effective performance in the case of manufacturing ink jet recording medium by providing an overcoat of a functional layer on a substrate having a layer such as an ink absorbing layer.

Ink jet recording sheets are being demanded to have various characteristics such as high image quality, absorption, absorption volume, weather resistance, corrosion resistance, color gradations, etc. In order to improve these characteristics, it is necessary to add additives. However, there are frequently limitations when the additives are added to the coating solution that forms the ink absorbing layer. Therefore, methods have been known of coating the layer that includes additives (hereinafter referred to as the functional layer) after coating of the ink absorbing layer. As said coating method, it is possible to use any known coating method such as a slide hopper coating, a curtain coating, extrusion coating, a spray coating, a fountain coater coating, etc. When coating the functional layer, it is possible to use the method of re-coating after the ink absorbing layer is coated, dried and wound, and the method of coating subsequent to coating of ink absorbing layer can also be used.

Among these, the most desirable form is the case of carrying out successive coating after the ink absorbing layer has been coated. In the case of this method, it is necessary to coat the functional layer after drying the ink absorbing layer to some extent, and it is desirable to coat the functional layer as a thin film considering the drying process.

The slide hopper coating, the curtain coating, and the spray coating can be considered as the desirable coating methods. Among these, the spray coating method is desirable which can be used to coat thin films.

In the manufacture of ink jet recording media, in order to coat these thin films of functional layer without non-uniformity and with high accuracy, the method of using a spray coating apparatus has been disclosed in Patent Documents 1 and 2.

However, in these documents, although descriptions have been given about the viscosity of the coating solution, the surface tension, etc., and also the internal pressure and flow rate of the gas etc. while spraying. Examinations have been also given about the angles of the coating solution nozzle and gas nozzle etc or the spreading angle etc., of the group of droplets of the spray liquid depending on these, and in addition, about the distance from the substrate to be coated. However much investigations have not been done about the spray coating apparatus or the spray coating condition with which it is possible to obtain uniformly coated films with very low generation of coating defects during coating such as liquid splashes, mottle, streaks, etc and with aggregation or precipitation of additives on the ink absorbing layer suppressed.

In consideration of the above circumstances, the present invention proposes a manufacturing apparatus by which even in the case of coating, by a spray method, on a substrate (object to be coated) having a coated layer and being continuously conveyed, high speed coating becomes possible without the generation of coating defects, and a manufacturing method in which the apparatus is used.

Patent Document 1: Japanese Patent Application Tokkai No. 2003-326836

Patent Document 2: Japanese Patent Application Tokkai No. 2004-906

Therefore, an object of the present invention is to obtain a spray coating apparatus and a spray coating method, for example in the case of manufacturing an ink jet recording medium, to coat a layer that includes additives (hereinafter referred to as a functional layer) on an object to be coated (substrate) that already has a coated layer, whereby it is possible to carry out efficient, high speed, and stable overcoating with low occurrence of coating defects such as liquid splashes, mottle, streaks, etc., and also solving problems of aggregation or precipitation, etc. of the additives on the surface of the ink absorbing layer in order to manufacture a high quality ink jet recording medium.

Specifically, an object of the present invention is to provide a spray coating apparatus and a spray coating method which makes it possible to manufacture ink jet recording sheets with high quality at the time of manufacturing an ink jet recording medium by providing additionally an overcoat of the solution that includes additives after forming a porous ink absorbing layer on the substrate by coating.

The inventors obtained knowledge that unevenly coated films can be made in spray coating and these are due to non-uniformity of the adhesion of additives added to a functional layer, and that such non-uniformity of adhesion are caused by changes in the distance from the tip of the slot nozzle to the coating portion in the condition before coating and during coating. Because of this, in order to obtain a uniformly coated film, it has been considered that it is important to suppress the amount of change of this distance to less than a specific value, and the inventors conducted examinations regarding the permissible tolerance value of this amount of change and the means for keeping this permissible tolerance value and have achieved the present invention.

### SUMMARY OF THE INVENTION

An object of the present invention is achieved by the following apparatus and method. (A) A spray coating apparatus comprising: a conveying device to convey a substrate to be coated in a conveyance direction; a spray head disposed to extend in a direction crossing the conveyance direction to coat a coating solution on the substrate; a tensioning device to provide a predetermined degree of tension to the substrate in a coating portion of the spray head; wherein the tensioning device maintains a variation of average positions of a surface of the substrate in the coating portion from a tip of the spray head between prior coating and during coating to be within 0.5% width of the substrate perpendicular to the conveyance direction. (B) A spray coating method comprising steps of: conveying a substrate to be coated in a conveyance direction; coating a coating solution on the substrate by a spray head disposed to extend in a direction crossing the conveyance direction; providing a predetermined degree of tension to the substrate in a coating portion of the spray head; wherein a variation of average positions of a surface of the substrate in the coating portion from a tip of the spray head between prior coating and during coating is maintained to be within 0.5% width of the substrate perpendicular to the conveyance direction in the providing step of providing the tension.

### BRIEF DESCRIPTION OF THE DRAWINGS

FIG. 1 is an outline diagram for explaining the coating apparatus of the present invention.

FIG. 2 is a schematic cross-sectional diagram of a slot nozzle spray apparatus that includes a slot nozzle spray section.

FIG. 3 is a diagram explaining the slot nozzle spray section and the formation of droplets and the state of spray of droplets formed in the slot nozzle spray section.

FIG. 4 is a schematic diagram of the slot nozzle spray section as viewed from the side of the coating solution discharge section.

FIG. 5 is a schematic diagram of the slot nozzle spray section of another embodiment as viewed from the side of the coating solution discharge section.

FIG. 6 is a schematic diagram of the slot nozzle spray section of another embodiment as viewed from the side of the coating solution discharge section.

FIG. 7 is an exploded perspective diagram of the slot nozzle spray section having a coating solution discharge section of the type of FIG. 5.

FIG. 8 is a schematic diagram showing an example of a coating manufacturing line in which a slot nozzle spray apparatus is installed.

FIG. 9 is a schematic diagram showing the coating solution discharge section of the slot nozzle spray section and the coating section of the substrate.

FIG. 10 is a schematic diagram showing an example of an apparatus in which the substrate is on a backing roller in the coating solution discharge section of the slot nozzle spray section and in the coating section.

FIG. 11 is a schematic diagram showing an example of a slot nozzle spray apparatus having a belt as a supporting member that supports the substrate.

FIG. 12 is a schematic diagram showing an example of a slot nozzle spray apparatus with a backing roller.

### DETAILED DESCRIPTION OF THE PREFERRED EMBODIMENT

Next, although some preferred embodiments in implementing the present invention are described next, the present embodiment shall not be construed to be limited by these.
(1) The spray coating apparatus (A), wherein the predetermined degree of tension provided by the tensioning device is within a range from 98.0 N/m to 980 N/m.
(2) The spray coating apparatus (A), wherein the tensioning device maintains the variation to be 2 mm or less.
(3) The spray coating apparatus (A), further comprising: a supporting member to support the substrate while the supporting member is in contact with an opposite side surface of a surface of the substrate on which a coating solution from the spray head is coated.
(4) The spray coating apparatus (A), wherein the supporting member is a backing roller, and a bracing angle of the substrate in a coating portion around the roller is within a range from 5 to 180 degrees.
(5) The spray coating apparatus (A), wherein the supporting member has a suction function.
(6) The spray coating apparatus (A), wherein the supporting member is driven to rotate synchronizing with a conveyance of the substrate.
(7) The spray coating apparatus (A), wherein the substrate is composed of a support material and an ink absorbing layer coated on the support material, and coating of the ink absorbing layer and coating of an overcoat layer are carried out successively in a same line.
(8) The spray coating apparatus (A), wherein a coating speed of spray coating on the substrate is within a range from 50 m/min to 500 m/min.
(9) The spray coating method (B), wherein the predetermined degree of tension provided by the tensioning device is within a range from 98.0 N/m to 980 N/m.
(10) The spray coating method.(B), wherein the variation is maintained to be 2 mm or less in the providing step of providing the tension.
(11) The spray coating method (B), further comprising: a step of supporting the substrate by a supporting member which is positioned to be in contact with an opposite side surface of a surface of the substrate on which a coating solution from the spray head is coated.
(12) The spray coating method (B), wherein the supporting member is a backing roller, and a bracing angle of the substrate in a coating portion around the roller is within a range from 5 to 180 degrees.
(13) The spray coating method (B), wherein the supporting member has a suction function.
(14) The spray coating method (B), wherein the supporting member is driven to rotate synchronizing with a conveyance of the substrate.
(15) The spray coating method (B), wherein the substrate is composed of a support material and an ink absorbing layer coated on the support material, and coating of the ink absorbing layer and coating of an overcoat layer are carried out successively in a same line.
(16) The spray coating method (B), wherein a coating speed of spray coating on the substrate is within a range from 50 m/min to 500 m/min.

Details regarding the preferred embodiments will now be described below.

The present invention provides a spray coating apparatus and a spray coating method effective for the manufacturing of, for example, high quality ink jet recording sheets at the time of providing an overcoat of a solution that includes additives after coating a coating solution etc., that forms a porous ink absorbing layer on a support material to create the constituent layers of an ink jet recording medium such as ink absorbing layers, etc.

As a spray coating apparatus related to the present invention, a slot nozzle spray apparatus which coats by spraying the coating solution in the form of liquid droplets can be employed. It will now be explained as follows.

The substance to be coated, as described in the present invention, refers to an object to be coated while employing the coating apparatus of the present invention in which coating is carried out by spraying liquid droplets of a coating solution, and its structure is not particularly limited. It may be a substrate having already coated layer or may not. The aforesaid long belt shaped support materials as well as those including the aforesaid support material having thereon a composition layer are preferred because it is possible to efficiently exhibit the effects of the present invention. The substrates may be discrete flat board-shaped as well as non-flat shaped, and those in which portions to be coated have an area.

Further, in the present invention, the substance to be coated is allowed to move (be conveyed) relative to the coating solution discharge section of a coating apparatus, whereby continuous coating is performed. The coating solution discharge section of the coating apparatus has a width which corresponds to the coating width (which refers to the length of the coating portion of a substrate in the direction perpendicular to the conveyance direction of the aforesaid substrate) of the substrate, and is arranged to cross the conveyance direction of the substrate so that the coating solution is applied onto the substrate only by conveying the substrate with respect to the coating apparatus. When the substrate is long belt-shaped, it is preferable that the aforesaid belt-shaped substrate itself is allowed to be conveyed in the longitudinal direction thereof and the coating solution discharge section is positioned across the width (the direction perpendicular to the longitudinal direction) of the aforesaid belt-shaped substrate. By conveying the substrate in one direction with respect to the coating apparatus and spraying the coating solution across the coating width in the form of liquid droplets, it is possible to coat a very thin layer having an uniform layer thickness, with minimized drying load.

Further, across the coating width, liquid droplets, which are sprayed from the coating solution discharge section of the coating apparatus, are required to satisfy the following conditions:

1: The liquid droplet diameter distribution is uniform;

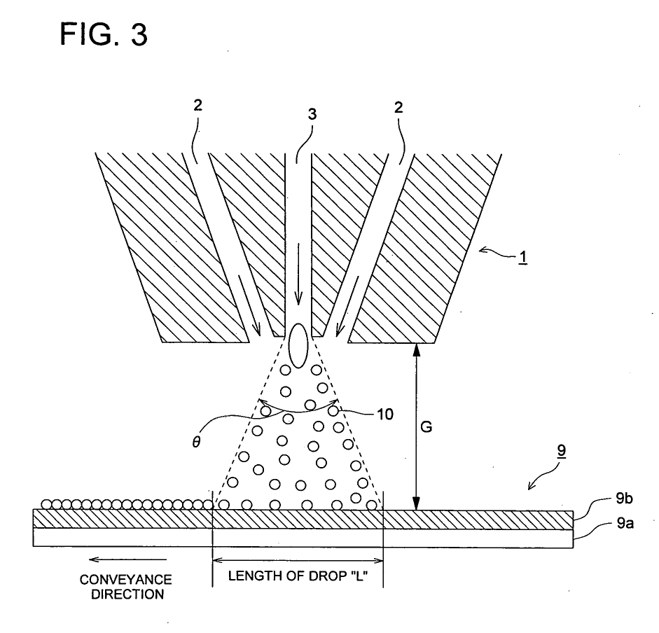

2: The length of drop in the conveyance direction of the area region, on which liquid droplets fall, is uniform (shown in FIG. 3 below);

3: The falling angle onto the substrate is uniform; and

4: The collision rate is uniform of liquid droplets fallen on the substrate.

Upon satisfying the aforesaid conditions, it becomes possible to assure further uniformity of the coating thickness.

The uniform droplet diameter across the coating width direction, as described herein, specifically refers to variation of the average liquid droplet diameter (to be explained later) of less than or equal to ±20 percent and preferably less than or equal to ±10 percent in the width direction.

It is possible to calculate the variation of the average liquid droplet diameter, employing a laser diffraction type particle size distribution measurement apparatus. The measurement method, described below, is specifically used.

First, coating solution is sprayed employing a spray apparatus such as a slot nozzle spray apparatus which sprays the aforesaid coating solution in the form of liquid droplets and the state of the resulting spray is stabilized. Immediately after initiating spraying, the resulting spray state is not stabilized due to variation of the discharge volume of the coating solution as well as variation of gas pressure. However, it is possible to achieve stabilization while continuing spraying after a specified time.

Regarding the variation rate of the liquid droplets, a laser diffraction type particle size distribution measurement apparatus (Spraytech RTS5123 (manufactured by Malvern Inc.) for example) is employed to measure a group of liquid droplets in which the spray state has been stabilized. Across the coating width, the average liquid droplet diameter is measured at five positions located at regular intervals. At both edges (coating edges) across the coating width of a group of liquid droplets which fall on the substance to be coated, the concentration of sprayed liquid droplets extremely decreases, whereby both edges are not included in the affective coating width. Accordingly, measurement points at both edges of the effective coating width are determined as two points at both edges. Specifically, a point which is located at 1 cm interior from the edge is used as a measurement point and two such points of both edges are used. Total five points, including three points in the interior which are positioned at regular intervals are employed as measurement points. Subsequently, a coefficient of variation is calculated, based on the average droplet diameter measured at the aforesaid five points.

Incidentally, it is possible to easily measure the average liquid droplet diameter, employing Sprayteck RTS5123. The diameter of individual droplets of a group of such liquid droplets is measured at the aforesaid measurement positions. Subsequently, when an integration plot is carried out while plotting the resulting liquid droplet diameter as the abscissa, the average droplet diameter refers to the liquid droplet diameter which locates at 50 percent by volume. The variation is less than or equal to ±20 percent.

Further, “the length in the conveyance direction of the area range in which liquid droplets fall is uniform” means that variation of the aforesaid length across the coating width is less than or equal to ±10 percent, and preferably less than or equal to ±5 percent.

It is possible to measure variation of the length in the conveyance direction in the area range of liquid droplets which fall on the substrate by visualizing the portion of a liquid droplet which comes into contact with the substrate.

To achieve the above uniform spray, a method to use an apparatus called a slot nozzle spray apparatus is cited. The slot nozzle spray apparatus has plural coating solution nozzle holes to spray a coating solution along the coating width. The coating solution nozzle holes may be arranged in a row or in a zigzag along the coating width. The slot nozzle spray apparatus also has gas nozzle holes close to the coating solution spray nozzle holes to discharge gas and has a function to allow the gas to collide with the coating solution discharged from the coating solution nozzle holes to form droplets. The coating solution nozzle hole may be a slit instead of plural nozzle holes.

As a slot nozzle spray apparatus to be used for the present invention, preferably used for the invention is one described in Official Gazette of Japanese Patent Tokkai No. hei 6-170308 or in Tokkai No. hei 5-309310.

When such slot nozzle spray apparatuses are employed, it is possible to enhance uniformity of the spray state across the coating width, as noted above, by employing methods in which the viscosity of the coating solution is adjusted to a relatively low level or the pressure of gas ejected from a gas nozzle is increased. Further, it is also possible to enhance uniformity of the aforesaid spray by decreasing the area of the nozzle opening of the coating solution of the slot nozzle spray apparatus as well as by decreasing the pitch of the aforesaid opening.

The viscosity of coating solution is preferably from 0.1 to 250 mPa·s, is more preferably from 0.1 to 50 mPa·s, and is still more preferably from 0.1 to 20 mPa·s. By supplying such a low viscous coating solution to the slot nozzle spray apparatus, it is possible to achieve a spray of uniform liquid droplets across the coating width.

When an ink jet recording medium is manufactured, it is preferable that the viscosity of a functional layer forming a solution including each of the additives is 100 mPa·s or less. If the viscosity exceeds 100 mPa·s, permeability to porous film layer degrades or non-uniformity is caused on the surface, resulting in reduced ink absorptivity. The preferable viscosity is from 0.5 to 20 mPa·s.

Still further, when liquid droplets are formed by allowing gas to collide with the coating solution while employing slot nozzle spray apparatuses, a uniform spray is easily achieved by employing gas having an inner gas pressure of at least 10 kPa, more preferably at least 20 kPa, and still more preferably at least 50 kPa. The flow rate of gas is commonly at least 3.5 CMM/m, is preferably at least 7 CMM/cm, and is more preferably at least 10 CMM/m.

The structure of the slot nozzle spray coating apparatus is not particularly limited, but one preferable example is shown below.

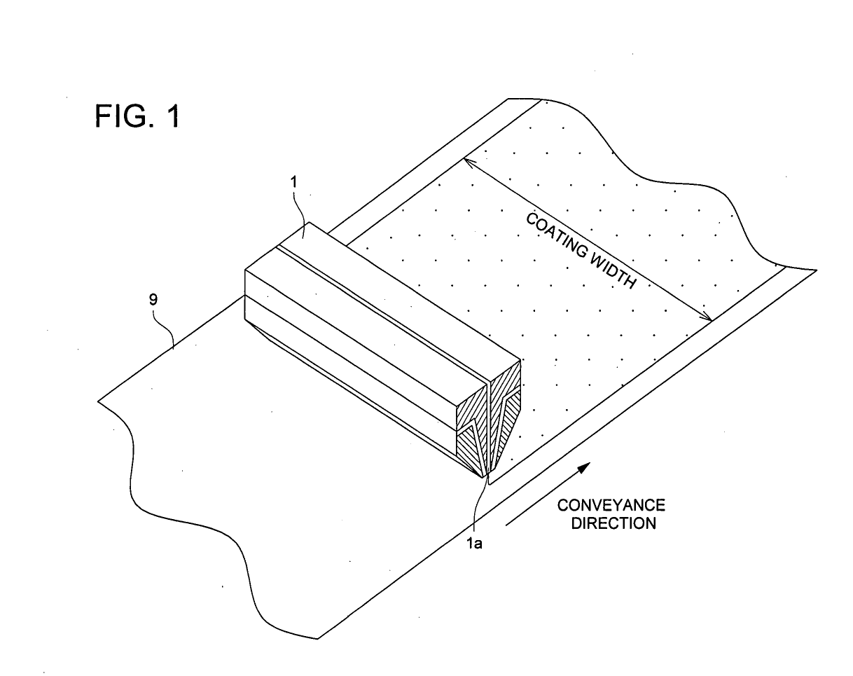

FIG. 1 is a schematic view describing the coating apparatus of the present invention. In FIG. 1, reference numeral 1 is the slot nozzle spray section of the slot nozzle spray apparatus (the entire apparatus is not shown), 9 is a substrate of a lengthy belt-shaped support material type. Substrate 9 is conveyed in the conveyance direction of the longitudinal direction of substrate 9 shown as an arrow in the drawing at a constant rate, employing a conveyance means (not, shown). Coating solution discharge section la of slot nozzle spray section 1 has its length across the width of substrate 9 which is perpendicular to the conveyance direction and is arranged so as to face the coating surface of substrate 9. The coating solution is sprayed in the form of liquid droplets and coating is carried out so that the resulting droplets impinge on conveyed substrate 9. In such a case, the coating solution adhesion length across the width of substrate 9 corresponds to the coating width shown by the arrow in FIG. 1. In FIG. 1, though the coating width is less than the length across the width of substrate 9, the same length or longer may be allowed.

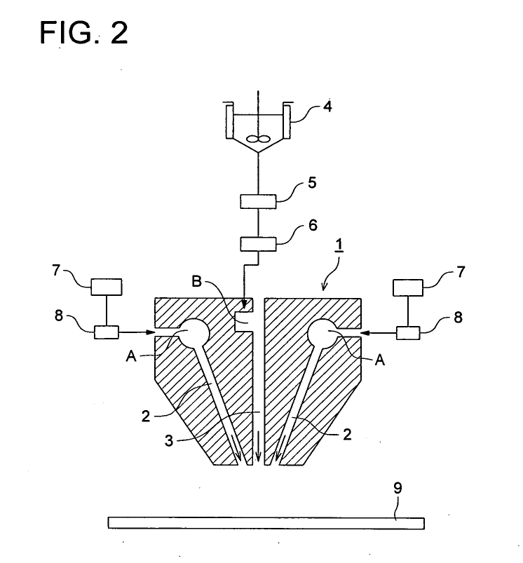

FIG. 2 is a schematic sectional view of a slot nozzle spray apparatus including slot nozzle spray section 1 illustrated in FIG. 1.

In FIG. 2, slot nozzle spray section 1 includes a pair of gas nozzles 2, having gas pocket A, and coating solution nozzle 3, having coating solution pocket B. A coating solution such as a functional layer forming solution, having a viscosity (preferably from 0.1 to 250 mPa·s), capable of forming liquid droplets without forming threads is fed into preparation tank 4, and subsequently is supplied to coating solution pocket B via pump 5 and flow meter 6, and is subsequently led to coating solution nozzle 3. On the other hand, pressurized air is supplied to pocket A via valve 8 from pressurized air source 7. During coating, the coating solution is supplied from preparation tank 4 so that the specified coating amount is discharged from coating solution nozzle 3. Simultaneously, pressurized air is ejected from a pair of gas nozzles, whereby the coating solution is shaped into liquid droplets which are sprayed onto substrate 9 to be impinged.

With reference to FIG. 3, described will be slot nozzle spray section 1, as well as the shape of liquid droplets formed therein and the ejected state of liquid droplets.

In FIG. 3, the coating solution, which is discharged from coating solution nozzle 3, is finely divided to form liquid particles, employing compressed air supplied from gas nozzle 2 which is installed adjacent to both sides of coating solution nozzle 3, whereby approximately spherical liquid droplets 10 are formed, which subsequently impinge uniformly on the surface of substrate 9 that is provided at spaced gap G from coating solution nozzle 3. FIG. 3 shows a model in which substrate 9 includes support material 9a having thereon an ink absorptive layer as a composition layer. It is preferable that the area range of liquid droplets of the coating solution, which impinge on substrate 9, remains uniform. It is also particularly preferable that the length in the conveyance direction (described as length of drop L in FIG. 3) remains uniform across the coating width. Further, it is preferable that spreading angle θ of a group of liquid droplets which are sprayed toward the substrate from the opening of coating solution nozzle 3 is uniform across the coating width.

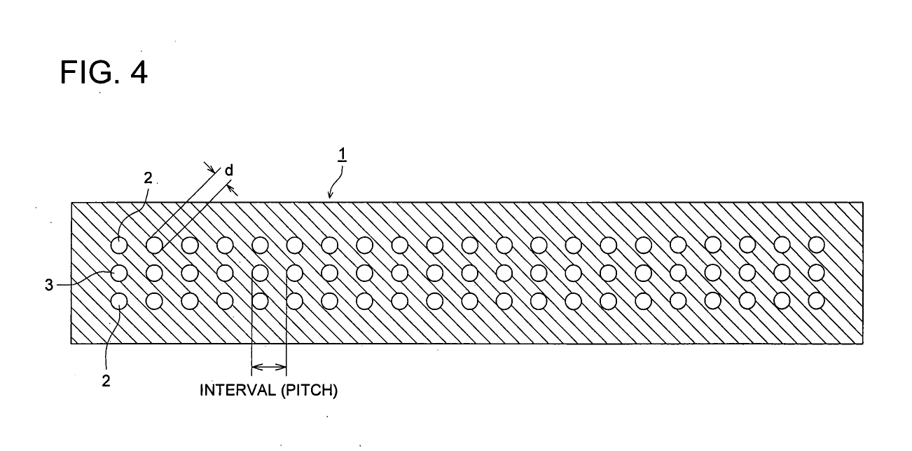

FIGS. 4, 5 and 6 are schematic views in which slot nozzle spray section 1 in FIG. 1 is viewed from the side of coating liquid discharge section 1a, and show a plurality of opening ends of coating solution nozzles 3 or slit nozzle 3 arranged across the coating width as well as the openings of gas nozzle 2.

In the coating solution discharge section shown in FIG. 4, twenty-one of coating solution nozzles 3, each having a circular end opening, are aligned across the coating width. Further, the embodiment is that gas nozzle 2 is installed adjacent to both sides of the opening end of each coating solution nozzle 3. Coating solution nozzles 3 are arranged at equally spaced intervals and similarly also each gas nozzle 2 is arranged at equally spaced intervals. In FIG. 4, two gas nozzles 2 paired with one coating solution nozzle 3 are aligned in the direction perpendicular to the coating width. However, coating solution nozzles 3 and gas nozzles 2 may be arranged in a zigzag pattern. It is preferable that the interval between openings of coating solution nozzle 3 or gas nozzle 2 remains at equally spaced intervals. It is preferable that the opening area is smaller and the pitch is also smaller.

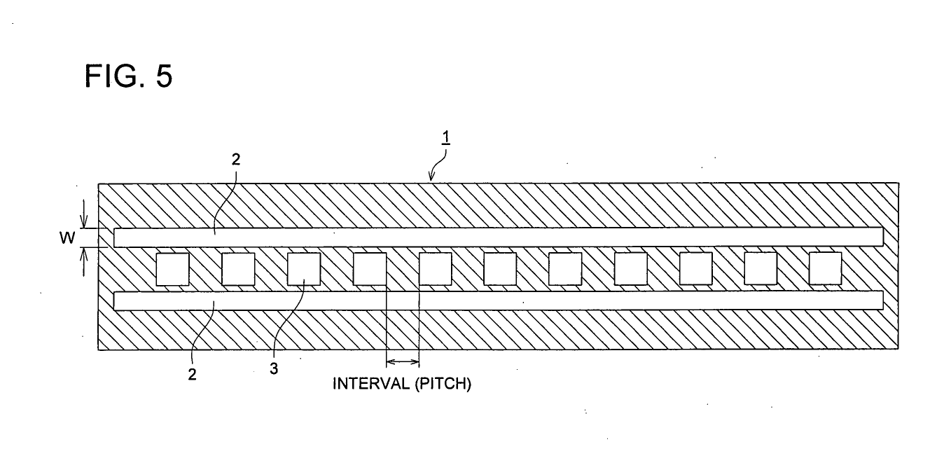

The coating solution discharge section shown in FIG. 5 is different from the one shown in FIG. 4. Eleven coating solution nozzles 3, having a rectangular opening, are aligned across the coating width. Further, across the coating width, one slit-shaped gas nozzle 2 is arranged adjacent to each side of the opening with respect to each of all coating liquid nozzles 3. In such an embodiment, a plurality of rectangular openings of the coating solution nozzle are arranged at equally spaced intervals.

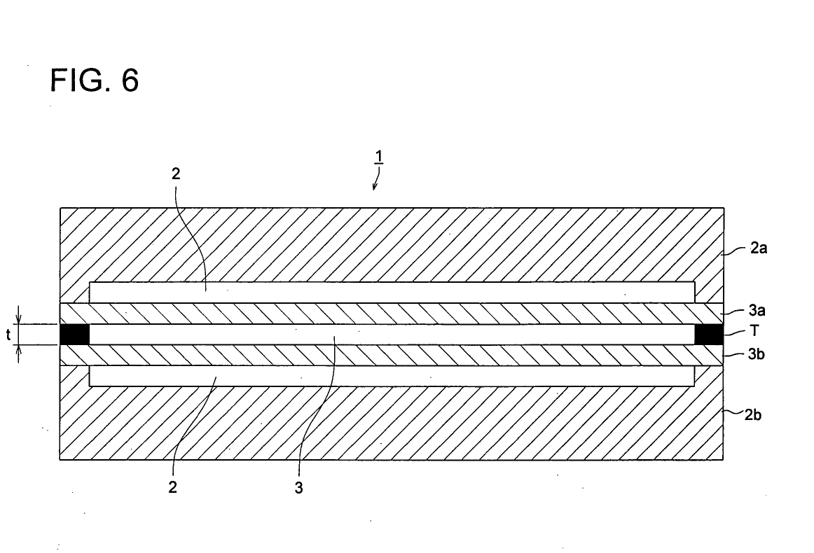

FIG. 6 is a schematic diagram of coating solution discharge portion showing a slot nozzle spray portion having a slit shaped coating solution nozzle 3 extending along the coating width viewed from the coating solution nozzle side. It shows the open end of the slit shaped coating solution nozzle 3 positioned in the coating width direction and the open end of the gas nozzle 2. In FIG. 6, a spacer T is installed in each of the both sides of the slit shaped coating solution nozzle 2 and a slit shaped coating solution nozzle 3 is formed by means of this. In FIG. 6, the slit shaped coating solution nozzle 3 is formed by using the spacer T, however, it may be formed by applying a groove to either inner die blocks 3a or 3b, for example. The paired gas nozzles 2 are provided on both sides of this coating solution nozzle 3 parallel to it.

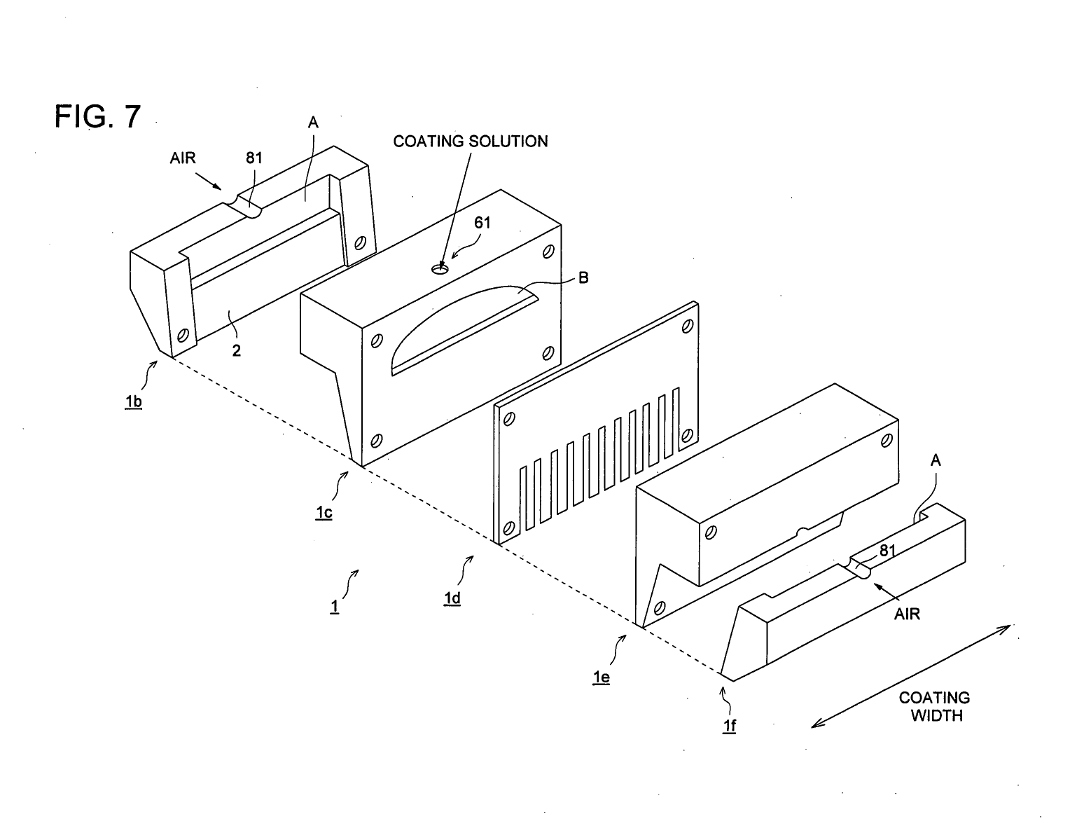

FIG. 7 is a perspective exploded view of slot nozzle spray section 1, including a coating solution discharge section analogous to that shown in FIG. 5. In FIG. 7, reference symbols 1c and 1e are die blocks which form a coating slit at the specified distance, and allow the coating solution to flow down the aforesaid slit. One die block 1c receives the coating solution supplied from a coating liquid supply source (not shown) and has a coating solution supply pipe 61 which allows the coating solution to pass into coating solution pocket B. The coating solution, which is retained in coating solution pocket B, flows down employing the coating solution slit formed between die blocks 1c and 1e. Symbol 1d is a shim (packing metal) interposed between block 1c and 1e. The slit for the coating solution is divided in the perpendicular direction so as to form a plurality of coating solution nozzles across the coating width.

Further, 1b and 1f each is a gas block and forms a gas nozzle in the gap of each of 1c and 1e, through which compressed gas passes. In such a case, the gas nozzle is a slit which extends across the coating width. Compressed air is supplied to air supply pipe 81 of each gas block from an air source (not shown), and after a temporary stay in gas pocket A, pressurized downward flow results through the gas nozzle formed in the gap between the gas block and the die block.

The coating solution, which flows down the space of aforesaid shim 1d and compressed air which has flown down two gas nozzles, are allowed to collide with each other in the coating liquid discharge section, which is the bottom section of slot nozzle spray 1, whereby liquid droplets are formed and impinge onto the substrate 9 which is to be coated.

In the slot nozzle spray apparatus employed in the present invention, the shape of the opening end of coating solution nozzle 3 may be either circular or rectangular. The usable size is in the range of 50 to 300 μm. Each pitch (interval) of them is preferably from 100 to 3,000 μm. Further, it may be a slit-shaped coating solution nozzle extending across the coating width direction as described above. In such cases, the slit interval (t shown in FIG. 6) is about 20 to 120 μm and is preferably 40 to 80 μm. On the other hand, the shape of the opening end of the gas nozzle may be either circular or slit-shaped extending across the coating width. In such cases, a usable circle diameter (d shown in FIG. 4) or slit interval (w shown in FIG. 5) is about 50 to 500 μm. The angle of the gas nozzle with respect to the coating solution nozzle is preferably in the range of 5 to 50 degrees. Further, it is possible to appropriately select the distance (G shown in FIG. 3) between the coating solution discharge section of the slot nozzle spray section and the substrate to be in the range of about 2 to 50 mm.

The supply rate of the coating solution from the coating solution nozzle is optional, since it varies depending on the desired coating layer thickness, the concentration of coating solution, the coating speed, and the like. However, the coating amount on the substrate is preferably in the range of about 1 to about 50 g/m². When the coating amount is less than 1 g/m², it is difficult to form a stable uniform coating layer, while when it exceeds 50 g/m², it becomes difficult to exhibit the desired effects of the present invention because of influence to the drying load. It is characteristic that the wet layer thickness of the coating solution is from 1 to 50 μm, and is preferably from 5 to 30 μm.

On the other hand, gases to be ejected from the gas nozzle are not particularly limited as long as they are suitable for coating, and common air is usually employed. Gas supply conditions are preferably in the range of more than 3.5 CMM/m (flow rate per the coating width). In such cases, from the viewpoint of achieving uniform coating, inner pressure in the gas nozzle is preferably at least 10 kPa.

From the viewpoint of being capable of effectively achieving the purposes of the present invention, the air flow velocity “v” is preferably from 126 to 400 m/s. Specifically, if “v” is more than 126 m/s, it is preferred from the viewpoint of coating and drying properties, while if “v” is less than 400 m/s, it is preferred from the viewpoint of a coating yield.

The “air flow velocity”, as described in the invention, refers to the air flow velocity immediately after the exit of the gas nozzle, which is determined employing a laser Doppler anemometer such as 1D FLV System 8851, produced by KANOMAX Inc. Further, the “coating yield”, as described herein, refers to a numerical expression of the amount of the coating solution applied onto a substrate divided by the amount of the total supplied coating solution×100 (in percent), which is calculated employing a gravimetric method. Namely, the amount of the coating solution applied to the substrate is calculated based on the weight difference prior to and after applying onto the substrate, while the amount of the total supplied coating solution is calculated based on the weight of the coating solution which is conveyed and supplied to the coating solution discharge section, i.e. an expression of the flow rate of the coating solution×coating time.

Further, in such cases, from the viewpoint of being capable of effectively achieving the purposes of the present invention, the average diameter D of liquid droplets of the coating solution is preferably from 10 to 70 μm. The “average diameter D of droplets of coating solutions”, as described in the present invention, refers to the average droplet diameter in the position of the coating gap (the distance G between the coating solution discharge section and the substrate), which is measured employing a laser diffraction type particle size measurement apparatus such as RTS114 produced by MALVERN Instruments Ltd.

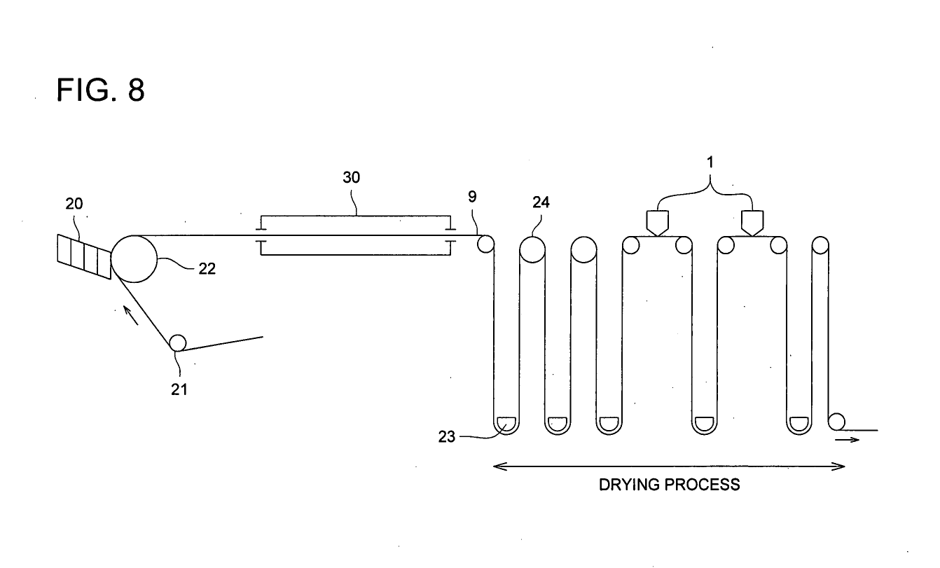

FIG. 8 shows one example of a coating production line provided with a slot nozzle spray apparatus as above. In FIG. 8, a substrate is employed which includes a support material coated with a composition layer. After coating the aforesaid composition layer on the support material, a plurality of slot nozzle spray apparatus (in a multistage format) is arranged in the drying process. Herein, forming the composition layer, as well as coating the overcoating layer (being the uppermost layer) according to the present invention in a single line, as stated above, is called “on-line coating”.

A substrate 9 from a master roll is allowed to pass over conveyance roller 21, employing a conveyance means (not shown). Subsequently, in the position of back-up roller 22, a porous ink absorptive layer (being a composition layer) coating solution, which is supplied from a flow rate regulating type slide bead coating apparatus 20, is coated. Since the porous ink absorptive layer coating solution includes hydrophilic binders, the resulting coating is temporarily cooled and set in cooling zone 30. Substrate 9, which includes the resulting support material having thereon the composition layer, is conveyed to a drying process. In the drying process, there are alternately arranged reverser 23 which blows air and achieves reverse conveyance in no contact with the coating layer surface, and an ordinary conveyance roller 24, whereby substrate 9 is subjected to meandering conveyance. In the aforesaid process, drying is carried out while blowing warm air (the warm air blowing means is not, shown). On the way of the aforesaid drying process, preferably after falling-rate drying, coating is carried out through liquid droplet spraying, as described in the present invention, employing two slot nozzle spray apparatuses 1 for example. Herein, two slot nozzle spray apparatuses are employed. However, the number of the apparatus may be only 1 or 3 or more.

When a thin layer is formed on the substrate, employing the coating apparatus of the present invention, the coating speed may not be necessarily specified, since it varies depending on the types of coating solutions, the concentration, the content of solvents, and the drying capacity. However, the coating speed is preferably from 50 to 500 m/minute, with more preferred coating speed being from 100 to 300 m/minute. The most uniform coating layer can be obtained in the above coating speed range.

In the coating apparatus of the present invention, when a layer is applied onto a substrate including a support material having thereon at least one composition layer, the subsequent coating is preferably carried out after the falling-rate drying of the composition layer formed on the support material, and is more preferably carried out after the drying end point. Further, it is preferable that a coating process in which the aforesaid composition layer forming is carried out, employing slide bead coating, and a coating process in which coating is carried out employing the slot nozzle spray apparatus of the present invention are continuously performed employing a single production line. Further, it has become known that applying coating according to the present invention before the composition layer has not been dried, tends to prevent demerits such as cracking on the composition layer.

When the composition layer already coated is absorptive like an ink absorbing layer, coating can be conducted efficiently because of the uniform formation of a thin layer on it.

It is possible to classify the drying process of a wet coating layer, as described below. An initial drying zone is called a constant-rate drying zone, in which since solutes in the coating solution, such as water and solvents, are evaporated while depriving latent heat of evaporation, the surface temperature of the composition layer remains almost constant. A section, in which temperature remains constant as above, is called a constant-rate drying zone. Following the constant-rate drying zone, water and solvents, which result in interaction with solutes of the coating solution, are evaporated, whereby other than the latent heat of evaporation, energy is required to be free from interactions. As a result, the surface temperature increases. Such a section is called a falling-rate drying zone. The falling-rate drying, as described herein, is a phenomenon which occurs when evaporation of solvents from the surface exceeds migration of water in the layer. When the falling-rate drying ends, a region starts in which the temperature of drying air is equal to the surface temperature of the ink jet recording medium. The resulting point is called the drying end point.

Confirming methods of the constant-rate drying zone, the falling-rate drying zone, and the drying end point are not particularly limited. They may be determined as follows. For example, upon monitoring surface temperatures, the region in which the surface temperature is constant is designated as the constant-rate drying zone, the region in which the surface temperature increases is designated as the falling-rate drying zone, and the point at which the surface temperature is the same as the drying temperature is designated as the drying end point.

Further, in another method, a water content meter is installed in each region and the water content of coating layers is monitored. The point at which the water content decrease curve flattens can be designated as the drying end point.

The coating method of the present invention is capable of uniformly forming a thin layer and may be applied to a wide variety of manufacturing fields. For example, it may be applied to provide a functional layer onto the uppermost surface of common silver halide light-sensitive materials, formation of reflection inhibiting layers, and coating of charge generating layers and charge transport layers on photoconductors employed in electrophotography. Particularly, it is preferably applied to coating of an overcoating layer onto ink jet recording media.

Ink jet recording media, to which manufacturing by using the coating apparatus of the present invention is preferably applied, each include a support material having thereon a porous ink absorptive layer composed of hydrophilic binders and minute particles as a composition layer. An overcoating layer is then applied onto the porous ink absorptive layer, employing the coating appratus of the present invention.

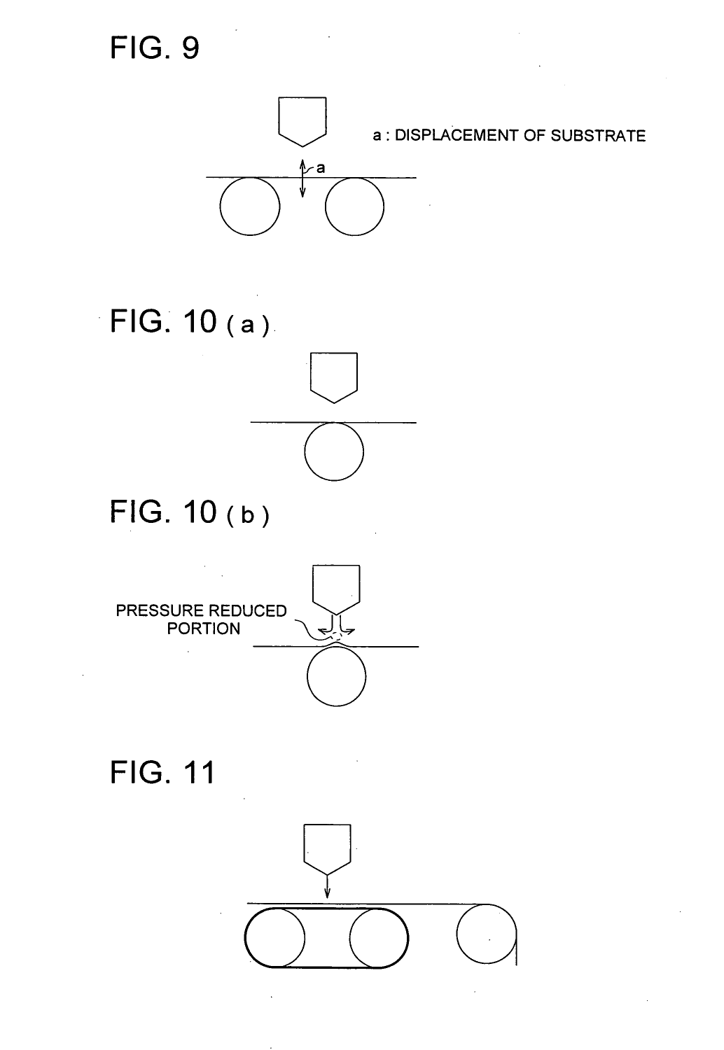

In the coating apparatus according to the present invention, the object to be coated (substrate) provided with ink jet recording medium constituent layers as coated layers is conveyed, and when an overcoat layer is to be coated by the spray coating apparatus, in order to form a uniform surface without non-uniformity or liquid splashes after coating the overcoat layer, it is important that the change in the position of the object to be coated (substrate) in the overcoat layer coating section from the tip of the slot nozzle (spray head) of the spray coating apparatus, that is, the amount of displacement (a) of the substrate in FIG. 9, is within 0.5% of the coating width in the condition before coating and during coating.

The amount of displacement of the position of the substrate, mentioned above, during coating relative to the position in the condition before coating is obtained by taking the average of the position of the surface of the substrate in the condition before coating as a reference point, and taking the average of the shift of the position of the substrate recorded during coating. The position of the substrate can be monitored using a displacement sensor while carrying out the coating.

As described above, although the distance (G shown in FIG. 3) between the coating solution discharge section of the slot nozzle spray section and the substrate can be selected appropriately and roughly in the range of 2-50 mm, in order to carry out uniform coating in a stable manner, it is necessary, for example, to maintain the distance between the spray nozzle section and the substrate appropriately.

FIG. 9 shows the coating solution discharge section of the slot nozzle spray section and the coating portion of the substrate, and the displacement (amount of displacement ‘a’) of the substrate due to the spray of the coating solution being discharged onto it.

FIG. 10 shows an example of an apparatus in which the substrate is on a backing roller in the coating solution discharge section of the slot nozzle spray section and in the coating section. Regarding the behavior above the backing rollers, it has been known that the spray liquid sprayed from the spraying section collides with the surface of the substrate and flows as shown in the figure, since the direction of a part of the spray is changed, in the coating section (at the point of collision with the spray), and since a reduced pressure state occurs on the substrate, because of this in the coating section of the substrate, the substrate floats up from the backing rollers in the coating section and causes liquid splashing or coating non-uniformity. Therefore, it is necessary also for a spray coating apparatus having a supporting member to strictly control the distance between the slot nozzle spray section and the substrate against such a phenomenon.

The amount of displacement ‘a’ which the variation of the substrate position is expressed between before coating and during coating, is normally 10 mm or less in an absolute value up to a preferable coating width of 2000 mm, and the smaller it is, the more preferable, so that it is more preferably 2 mm or less.

These changes in the position of the substrate imply that the substrate itself moves within this range, and the above values are the average values of such displacements (absolute values).

Specifically, it is possible to embed several displacement sensors (for example, eddy current sensors) at the tip of the slot nozzle along the width direction of coating (the number of sensors depends on the coating width and about 5 sensors would be sufficient for a coating width of 1 m), and to obtain the difference between the average values of the positions detected by each sensor during coating and the position in the condition before coating.

Therefore, to achieve this, for example, since these values change depending on the tension between the rollers etc., it is necessary to maintain the tension applied to the substrate between the rollers above said prescribed value in order to suppress not only the displacement of the substrate caused by reaction of the spray but also said floating up of the substrate due to reduction in pressure.

In a spray forming the spray of the coating solution from the slot nozzle spray section at said linear velocity, the tension applied to said object to be coated (substrate) in said overcoat layer coating section should preferably be 98.0 N/m or more, and by allowing the substrate to have sufficient tension, it is possible to prevent said floating-up of the substrate due to reduction in pressure not only when there is no supporting member such as a backing roller (for example, as shown in FIG. 9) but also when a supporting member such as a backing roller is present, and hence it is possible to suppress the displacement of the position of the substrate with respect to the slot nozzle. The upper limit of the tension should desirably be 980 N/m or less because if it is excessively high, it can cause deformation of the substrate which easily causes layer thickness non-uniformity.

As an apparatus applying the above tension to the object to be coated, it may be considered to have a structure of transmitting tensile force from a static load due to a weight, a spring, an air cylinder or a hydraulic cylinder to the object to be coated via a tension applying roller.

Further, in said spray coating apparatus, it is also desirable to have a supporting member that is in contact with the rear surface of said object to be coated (substrate) in said overcoat layer coating section as this makes the amount of displacement ‘a’ of the substrate small.

For the supporting member, it is possible to use, for example, a backing roller as is shown in FIG. 10, or a belt that supports the substrate while conveying it, as is shown in FIG. 11. The substrate is supported by these members on its rear surface, and hence even the displacement towards the backing roller or the belt in the distance from the tip of the slot nozzle can be suppressed by being supported by a supporting member having a prescribed hardness.

As a belt that is a supporting member, an endless belt formed by coating several surface layers on a base material is used. The base material of the belt can be made of a metal or resin, for example, a polyimide film with a thickness, for example, of about 100-1000 μm, which includes carbon black, etc. It is also possible to use other materials as long as it is superior in durability as a base material of the belt. On the other hand, it can also have a surface layer, and from the point of view of good close contact with the substrate material, it is also possible to form the surface layer using a resin layer and a rubber layer, etc. For example, it can have an elastic layer with a thickness, for example, of 5-200 μm using a silicone copolymer (DX35-547A/B manufactured by Toray Dow Silicone).

As a backing roller, it is possible to use a metal cylindrical roller with a roller external diameter, for example, of 50-300 mm, or a cylindrical roller made of aluminum on which resin (rubber) layers of about 2 mm thickness are coated.

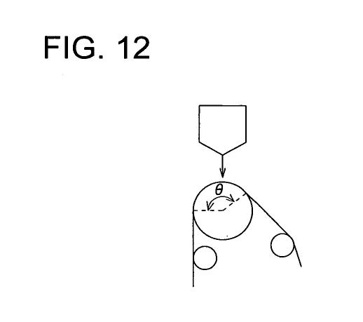

In addition, in another example of the spray coating apparatus according to the present invention, in order to prevent the displacement of said substrate from the tip section of the slot nozzle (spray head), as is shown in FIG. 12, under the condition that said overcoat layer is spray coated in the coating section while the substrate is conveyed over the backing roller, it is effective to allow the embracing angle (θ) of said object to be coated (substrate) around the backing roller to be within a range of 5°-180° so that the substrate is conveyed along with and in contact with the backing roller for a prescribed distance. The embracing angle is preferably 90°-180°. Because of this, the substrate is supported firmly by the backing roller, and it is possible to reduce said floating up of the substrate.

Further, a spray coating apparatus of a different form is described below that is suitable for suppressing definitely the variations in the distance (said amount of displacement) of the substrate from the tip section of the slot nozzle of the spray coating apparatus in said coating section.

In a spray coating apparatus, while it is desirable that the coating section has a supporting member such as a backing roller, a belt, etc., in contact with the back surface of the object to be coated (the substrate), in said overcoat layer coating section, it is still more desirable that the supporting member in contact with the back surface of the object to be coated (the substrate) on which the spray impinges has a suction function. By having the suction function, the floating up of said substrate is suppressed, a close contact between the substrate and the supporting member becomes definite, and the displacement of the substrate position relative to said slot nozzle becomes improved.

In this form, for example, the backing roller is porous and has a suction means that sucks air at the surface of said backing roller from the inside of said backing roller. It is desirable that the porous backing roller has fines holes of diameter about 50 μm-200 μm. Because of this structure, it becomes possible to remove the air layer that gets inserted between the backing roller and the substrate, and the contact between the substrate and the supporting member is ensured, and thus makes it possible to coat the film with a uniform thickness.

Although there is no particular restriction on the material of the backing roller, it is desirable that the punctured part area in the surface of the backing roller is in the range of 5% -50%. From the point of view of maintaining the accuracy of the surface characteristics and straightness of the backing roller, it is desirable that the material is a sintered metal. It is desirable that the suction pressure due to the suction means is in the range of 4.90×10 kPa-5.89 Pa.

It is desirable that these supporting members such as backing rollers or belts with a suction function are driven in a rotational manner in synchronization with the conveyance of the object to be coated (the substrate). Generation of a slip between the conveyance of the substrate and the supporting member is not desirable because abrasion scratches can be caused due to the friction between the back surface of the substrate and the supporting member when the supporting member is one having said hardness, or when the tensile force acting on the substrate is large.

The effect is much larger when several of said means for maintaining the displacement of the substrate at a small value are implemented simultaneously. For example, it is possible to have a combination of the tension of the substrate and backing roller, or, tension and the suction function of the belt, etc. Further, it is possible to have other combinations as well.

The details of the ink jet recording medium will now be explained. The ink jet recording medium which it is effective to manufacture by using the present invention is made by coating of a water-soluble coating solution forming a porous layer including a hydrophilic binder and fine particles onto a support material to form a porous ink absorbing layer having air spaces.

A porous ink absorbing layer related to the invention is formed by mainly micro-particle a hydrophilic binder. As micro-particles which can be used in the invention are inorganic micro-particles or organic micro-particles, however, inorganic micro-particles are especially preferable because they are highly glossy, high coloring density is obtained and its particles are procured more easily. As inorganic micro-particles like the above, cited can be, for example, white inorganic pigments, such as precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatom earth, calcium silicate, magnesium silicate, synthetic amorphous silica, colloidal silica, alumina, colloidal alumina, pseudo boehmite, aluminum hydroxide, lithophone, zeolite, and magnesium hydroxide, etc. Primary particles of said fine inorganic particles may be employed without any further modification, and said inorganic particles may also be employed in the state in which secondary coagulated particles are formed.

In the present invention, from the viewpoint of preparing high quality prints utilizing ink jet recording sheets, preferred as fine inorganic particles are alumina, pseudo-boehmite, colloidal silica, and fine silica particles synthesized employing a gas phase method. Of these, fine silica particles synthesized employing a gas phase method are particularly preferred. Said silica synthesized employing a gas phase method, whose surface is modified with aluminum may be employed. The content ratio of aluminum in the gas phase method silica whose surface is modified with aluminum is preferably from 0.05 to 5 percent by weight with respect to the total silica.

The diameter of said fine particles in the porous layer is not particularly limited, however, the average diameter is preferably not more than 1 μm. When said diameter exceeds 1 μm, the glossiness as well as color forming properties tends to be deteriorated. Therefore, said diameter is more preferably no more than 0.2 μm, and is most preferably no more than 0.1 μm. The lower limit of said diameter is not particularly limited, however, from the viewpoint of producing said fine particles, said lower limit is preferably not less than approximately 0.003 μm, and is more preferably not less than 0.005 μm.

The average diameter of said fine particles is obtained as follows. The cross-section and surface of a porous layer are observed employing an electron microscope, and the diameter of 100 randomly selected particles is determined. Then, said average diameter is obtained as a simple average (being a number average), based on the obtained data. Herein, each particle diameter is the diameter of the circle which has the same area as the projection area of each particle.

Further, from the viewpoint of glossiness as well as color forming properties, the degree of dispersion of fine particles in the porous layer is preferably no more than 0.5. When said degree of dispersion exceeds 0.5, the resulting glossiness as well as color forming properties of the image printed tends to be deteriorated. Said degree of dispersion is most preferably no more than 0.3. The degree of dispersion of fine particles, as described herein, refers to the value obtained by dividing the standard deviation of the particle diameter by the average particle diameter which is determined by observing the fine particles of the porous ink absorbing layer in the same manner as for determining the aforesaid average particle diameter.

The above fine particles may be located in the porous ink absorbing layer in the form of primary particles which are not subjected to any modification, secondary particles, or higher order coagulated particles. However, said average particle diameter refers to the average diameter of particles which form independent particles in the porous layer when observed with an electron microscope.

The content of said fine particles in the water-soluble coating solution is preferably from 5 to 40 percent by weight, and is more preferably from 7 to 30 percent by weight.

The porous ink absorbing layer may contain any commercial hydrophilic binders, for example, gelatine, polyvinyl pyrolidone, polyethylene oxide, polyacrylamide, and polyvinyl alcohol. Polyvinyl alcohol is a polymer which interacts with inorganic micro-particles, resulting in very high retentivity to the inorganic micro-particles, and further is a polymer exhibiting relatively small humidity dependency of hygroscopic property, resulting in relatively lower shrinkage stress during of coating, and further exhibits superior aptitude to cracking during drying of coating, being an object of the invention. Polyvinyl alcohols preferably employed in this invention, include, in addition to regular polyvinyl alcohol obtained by hydrolysis of polyvinyl acetate, modified polyvinyl alcohol such as polyvinyl alcohol whose terminals are modified by cations and also anionic modified polyvinyl alcohol incorporating anionic groups.

Polyvinyl alcohol of an average degree of polymerization of 300 or more which is obtained by hydrolyzing vinyl acetate is preferably used, and the polyvinyl alcohol of an average degree of polymerization of 1,000-5,000 is more preferable. Moreover, polyvinyl alcohol of saponification degree of 70-100% is preferable, and 80-99.5% is more preferable.

Cation denatured polyvinyl alcohol is polyvinyl alcohol which has an amino group of the primary to tertiary class, and quaternary ammonium in the main chain or side chain of the above polyvinyl alcohol, which is described in Tokkaisyou No. 61-10483, for example, and is obtained by saponifying the copolymer of the ethyleny unsaturated monomer which has a cationic group, and vinyl acetate.

As an ethyleny unsaturated monomer which has a cationic group, the following are cited, for example: trimethyl-(2-acrylamide-2,2-dimethyl ethyl) ammonium chloride, trimethyl-(3-acrylamide-3,3-dimethyl propyl) ammonium chloride, N-vinyl imidazole, N-vinyl-2-methylimidazole, N-(3-dimethylaminopropyl) methacrylamide, hydroxyl ethyl trimethyl ammonium chloride, trimethyl-(2-methacrylamide propyl) ammonium chloride, N-(1,1-dimethyl-3-dimethylaminopropyl) acrylamide.

The ratio of cation denatured group inclusion monomer of cation denatured polyvinyl alcohol is commonly 0.1 to 10 mole percent but is preferably 0.2 to 5 mole percent compared to vinyl acetate.

Cited examples of anion denatured polyvinyl alcohol are polyvinyl alcohol including anionic groups described in Tokkaihei No. 1-206088, copolymers of vinyl alcohol and vinyl compounds including water-soluble groups described in Tokkaisyou Nos. 61-237681 and 63-307979 and denatured polyvinyl alcohol including water-soluble group described in Tokkaihei No. 7-285265.

As nonion denatured polyvinyl alcohol, cited example are polyvinyl alcohol derivative in which a polyethylene oxide group is added to a part of vinyl alcohol described in Tokkaihei No. 7-9758, block copolymer of vinyl compound including a hydrophobic group and vinyl alcohol described in Tokkaihei No. 8-25795.

It is also possible to use combinations of two or more sorts of polyvinyl alcohol with different polymerization degrees or denaturation. Specifically, in cases when polyvinyl alcohol of a polymerization degree of 2,000 or higher is employed, it is preferable to first add to inorganic micro-particle fluid dispersion, 0.05-10 percent by mass or more preferably 0.1-5 percent by mass of polyvinyl alcohol against inorganic particles, being of a polymerization degree of 1,000 or less, and then to add polyvinyl alcohol of a polymerization degree of 2,000 or more, which tends to suppress drastic increases in viscosity of the solution.

The ratio of fine particles against a hydrophilic binder in a porous ink absorbing layer is preferably 2 to 20 based on a weight ratio. When the weight ratio is less then 2 times, void ratio of a porous ink absorbing layer is reduced and it is difficult to obtain a sufficient void volume and it induces the situation of clogging the void due to swelling of an excessive hydrophilic binder at the time of ink jet recording, which is a factor to reduce the ink absorption rate. While, when the ratio is more than 20 times, cracking unfavorably tends to cause in the case of coating a thick porous layer. A specifically preferable ratio of fine particles against a hydrophilic binder is 2.5 to 12 times and most preferably 3 to 10 times.

Employed as support materials which are used in ink jet recording media of the present invention may be water absorptive support materials (such as paper) as well as non-water absorptive support materials. From the viewpoint of ability of producing higher quality prints, non-water absorptive support materials are preferable.

By using a water absorbing support material, not only it is difficult to obtain high-quality print but also it results in deterioration of the effect of additives because the overcoated component of each additive disperses in the paper after coating.

As water-phobic absorbent substrate which is preferably used are such as polyester system film, polyester system resin, diacetate system film, triacetate system film, polyolefin system film, acrylic system film, polycarbonate system film, polyvinylchloride system film, polyimide system film, a transparent substrate or an opaque substrate made of cellophane, and celluloid, are cited, as examples. Resin coated paper (so-called RC paper) having polyolefin resin coated layer on both sides of the base paper is also used.

To increase adhesive strength between the surface of a substrate and a coated layer, applying a corona discharge treatment or a sub-coating on the substrate is preferable prior to coating of the aforesaid water soluble coating solution for ink absorbing layer forming on the above substrate. The recording sheet related to the present invention is not necessarily colorless and can be a colored recording sheet.

The support material preferably used in the invention is a transparent polyester film, an opaque polyester film, an opaque polyolefin resin film and a paper support material both sides of which are laminated with a polyolefin resin. The paper support material laminated with a polyolefin resin related to the invention is especially preferable, and it can eliminate the drying process substantially when a small amount of overcoating solution is coated.

A paper support material laminated with polyethylene representing polyolefin, being most preferable, will now be explained.

The base paper used for paper substrate mainly contains wood pulp, and is manufactured, with synthetic pulp such as polypropylene or synthetic fiber such as nylon and polyester added to the wood pulp, as required. Any of LBKP, LBSP, NBKP, NBSP, LDP, NDP, LUKP and NUKP can be used as wood paper. Among these kinds of paper, LBKP, NBSP, LBSP, NDP and LDP containing a greater amount of short fiber are preferably contained in greater amounts. However, the ratio of the LBSP and/or LDP is preferred to be 10 to 70 percent by mass.

Chemical pulp containing less impurities (sulfate pulp or sulfite pulp) is preferably used as the aforementioned pulp. The pulp with the whiteness improved by bleaching is also useful.

As required, base paper can be mixed with a sizing agent such as higher aliphatic acid and alkyl ketene dimer; a whitening agent such as calcium carbonate, talc and titanium oxide; a paper strengthening agent such as starch, polyacryl amide and polyvinyl alcohol; an optical brightening agent, a moisture retaining agent such as polyethylene glycol, a dispersant and a softening agent such as quaternary ammonium.

The water filtering degree of the pulp used for paper making is preferably 200 through 500 ml according to the provision of CSF. The length of fiber after beating is preferably such that the sum of percent by mass of the residue on 24-mesh and percent by mass of the residue on 42-mesh is 30 through 70 as specified in the JIS-P-8207. It is preferred that the percent by mass of the residue on 4-mesh should not exceed 20.

The basis weight of base paper is preferably 30 through 250 g/m². Especially preferred basis weight is 50 through 200 g/m². The thickness of paper is preferably 40 through 250 μm. Base paper can be provided with a higher degree of smoothness by calendering process during or after paper making. The commonly used base paper density is 0.7 through 1.2 g/cm³ (according to JIS-P-8118). Further, the stiffness of base paper is preferably 20 through 200 g under the conditions specified in the JIS-P-8143. A surface sizing agent can be applied on the surface of paper. As the surface sizing agent, one similar to aforementioned sizing agent that can be added in the base paper may be used. The pH value of base paper is preferably 5 through 9 when measured according to the hot water extraction method specified in the JIS-P-8113.

The polyethylene covering the obverse and reverse sides of base paper is mostly low density polyethylene (LDPE) or high density polyethylene (HDPE). Other LLDPE and polypropylene can also be used partly.

Particularly, a polyethylene layer on the coated layer side is preferably one opacity and whiteness of which having been improved by adding titanium oxide of rutile or anatase type in polyethylene as is commonly applied in photographic print paper. The content of titanium oxide is generally 1-20 weight % and preferably 2-15 weight %, based on polyethylene.

Polyetylene coated paper can be employed as glossy paper as well as paper provided with micro structure surfaces such as a matte surface or silky surface as obtained with conventional photographic print paper, which can be prepared by a so-called embossing treatment when polyethylene is coated by fusing extrusion on the base paper surface.

The using amounts of polyethylene on the front and back surfaces of base paper are determined so as to optimize the curl under low and high humidity after provision of a back layer as well as from the layer thickness of the water-soluble coating solution, and generally, are in a rage of 20-40 μm for the side of a polyethylene layer of the water-soluble coating solution related to the invention and 10-30 μm for that of the back layer side.

Further, the above-described polyethylene laminated paper substrate is preferably provided with the following characteristics.

(1) Tensile strength: that in the longitudinal direction is preferably 20-300 N and in the lateral direction is 10-200 N in terms of strength specified in JIS-P-8113.

(2) Tear strength: that in the longitudinal direction is preferably 0.1-2.0 N and in the lateral direction is 0.2-2.0 N in terms of strength specified in JIS-P-8116.

(3) Compressive elastic modulus: it is preferably at least 1030 N/cm².

(4) Surface Beck smoothness: it is preferably at shortest 500 seconds for a glossy surface under the conditions specified in JIS-P-8119, however, may be shorter than this for so-called embossed products.

(5) Back surface Beck smoothness: it is preferably 100-800 seconds under the conditions specified in JIS-P-8119.

(6) Opacity: transmittance of light within the visible range is preferably at most 20% and specifically preferably at most 15% under the measurement condition of direct incident light/diffusion light transmission.

(7) Whiteness is preferably at least 90% when it is measured as Hunter whiteness specified in JIS-P-8123. Further, L*=90-98, a*=−5−+5 and b*=−−10−+5 are preferable when these are measured based on JIS-Z-8722 (non-fluorescent) and JIS-Z-8717 (containing fluorescent agents) and represented in terms of the color indication method specified in JIS-Z-8730.

Under-coat layer may be provided on the ink absorbing layer side of the aforesaid substrate, for the purpose of enhancing adhesion with the ink absorbing layer. Binders for the under coat layer are preferably hydrophilic polymers such as gelatin and polyvinyl alcohol, and latex polymers having a Tg of −30 to 60° C. These binders are employed in a range of 0.001 to 2.0 g per 1 m² of a recording sheet. A small amount of an anti-static agent such as a cationic polymer which are commonly known may be incorporated in the under-coat layer for the purpose of improving anti-static properties.

On the surface opposite to the ink absorbing layer of the aforesaid substrate, a back layer may be provided on the purpose of improving sliding properties and anti-static properties. Binders for the back side layer are preferably hydrophilic polymers such as gelatin and polyvinyl alcohol, and latex polymers having a Tg of −30 to 60° C, and further, also added can be anti-static agents such as a cationic polymer, various kinds of surfactant in addition to matting agents having an average particle diameter of approximately 0.5-20 μm. The thickness of the back layer is generally 0.1-1.0 μm, however, it is approximately within a range of 1-20 μm when the back layer is provided for the purpose of anti-curling. Further, the back layer may be constituted of two or more layers.

When said subbing layer, as well as said back layer, is coated, surface treatments such as a corona treatment or a plasma treatment applied onto the substrate surface are preferably employed in combination.

Various kinds of additives can be incorporated in the water-soluble coating solutions forming the above ink absorbing layer. Such additives include, for example, such as cationic mordants, cross-linking agents, surfactants (for example, cationic, nonionic, anionic or amphoteric), white back ground tone controlling agents, fluorescent whitening agents, anti-mold agents, viscosity controlling agents, low boiling-point organic solvents, high boiling-point organic solvents, latex emulsions, anti-fading agents, UV absorbents, polyvalent metallic compounds (being water-soluble or non-water-soluble), matting agents and silicon oils. Among them preferably employed is a cationic mordant with respect to improving water resistance and moisture resistance after printing.

The cationic mordant that is used is a polymer mordant containing the primary, secondary and tertiary amino groups and quaternary ammonium base. Use of a polymer mordant containing the quaternary ammonium base is preferred because it is comparatively free from discoloration and deterioration of resistance to light after a long term, and is provided with a sufficiently high mordanting performance of the dye.

The preferred polymer mordant is obtained as a homopolymer of the monomer containing the aforementioned quaternary ammonium base, a copolymer with other monomers or a condensation polymer.

Further, it is particularly preferred to incorporate cross-linking agents of hydrophilic binders. By employing said cross-linking agents, the water resistance of the porous layer is enhanced, and in addition, the ink absorbing rate is also enhanced during ink jet recording due to the fact that the swelling of said hydrophilic binders is retarded.

Cross-linking agents may be employed, which include inorganic cross-linking agents (for example, chromium compounds, aluminum compounds, zirconium compounds, and boric acids), and organic cross-linking agents (for example, epoxy based cross-linking agents, isocyanate based cross-linking agents, aldehyde based cross-linking agents, N-methylol based cross-linking agents, acryloyl based cross-linking agents, vinyl sulfone based cross-linking agents, active halogen based cross-linking agents, carbodiimide based cross-linking agents, and ethyleneimine based cross-linking agents).

The content ratio of said cross-linking agents is commonly from about 1 to 50 percent by weight with respect to the hydrophilic binder, and is preferably from 2 to 40 percent by weight.

When said hydrophilic binders are composed of polyvinyl alcohols and fine articles are composed of silica, particularly preferred as cross-linking agents are inorganic cross-linking agents such as boric acids and zirconium compounds, as well as epoxy based cross-linking agents.

As a specifically preferable form, in the case where a polyvinyl alcohol and silica fine particles are used, using a boric acid or its salt is preferable because when the temperature of the water-soluble coating solution is lowered, the viscosity of the solution rises greatly and disturbance on the coated film is suppressed even if strong air blast is blown onto the surface of the coated film, resulting in easy high-speed coating. The boric acid or its salt refers to the oxyacid having a boron atom as a central atom and the salt thereof. To put it more specifically, it includes orthoboric acid, metaboric acid, hypoboric acid, tetraboric acid, pentaboric acid and salts thereof (sodium salt, Potassium salt, ammonium salt for example).

Although the quantity of boric acid or its salts used can change over a wide range depending on the concentration of inorganic fine particles or polyvinyl alcohol in the coating solution and on the pH, etc., it should be about 5% -60% by weight with respect to polyvinyl alcohol, and preferably be in the range 10% -40%.

Further detained description is given here about the coating solution that includes boric acid. In the case of a coating solution that includes the above boric acid and polyvinyl alcohol as a hydrophilic binder, if its viscosity at 15° C. is more than 20 times its viscosity at 40° C., it is possible to dry it by blowing a strong blast of air onto it after the coated film is coated, cooled and is made to set, and this is desirable from the point of view of high speed coating and drying characteristics. The desirable increase in the viscosity at 15° C. is, about 50 or more times the viscosity at 40° C., and it is particularly desirable that it is more than 100 times. Further, although the temperature at the time of coating is usually 30-50° C., and it is preferable that the viscosity of the coating solution at 0° C. is on the order of 10-500 mPa·s because the handling characteristics of the coating solution is favorable. The viscosity here is the value measured using a Type B viscometer.

In order to obtain the above type of physical characteristics of the coating solution, an effective means is to make the hydrophilic binder and the inorganic fine particles have a mutual effect of hydrogen coupling characteristics. Since this hydrogen coupling is a relatively weak coupling, it can easily be broken due to molecular vibration by increasing the temperature, and hence the viscosity can easily be low at high temperatures and high at low temperatures. Therefore, after the above water soluble coating solution is coated on the supporting body, it is desirable as has been described above to cool the coated liquid and increase its viscosity substantially.

The coating temperature of the coating solution is commonly from 30 to 60° C. Cooling temperature after coating may be controlled so that the temperature of the resulting coating layer is less than or equal to approximately 20° C. Specifically, it is preferable to control the temperature to be less than or equal to 15° C.

After coating, it is possible to cool the resulting coating upon passing it through a cooling process composed of cooling zones, cooled at, for example, 15° C. or lower for a specified time (preferably at least 5 seconds). From the viewpoint of preparing a uniform coating layer without mottling while minimizing unevenness, it is preferable that it is not subjected to strong air flow during cooling.

After once the coating layer is cooled, the viscosity of the coating solution itself increases, and even though strong air flow is applied, the unevenness of the coating layer can be minimized. Even though it is possible to blow air at 20° C. or higher, it is preferable that the temperature of air is increased gradually.

After applying the coating solution onto a support material, the resulting coating is dried employing a drying process. In such drying process, the resulting coating is subjected to blown air and is allowed to pass through high temperature zones, or is subjected to combination of both.

When drying is carried out by passing the coating through high temperature zones, temperatures of the drying zones are from 50 to 150° C. In such cases, it is preferable to select a suitable drying temperature while taking into account the heat resistance of support materials as well as adverse effects to coating layers. The relative humidity of the drying air is commonly from 10 to 50 percent, and is preferably from 15 to 40 percent. Drying time varies depending on the wet layer thickness, but is preferably at most 10 minutes, and is more preferably at most 5 minutes.

Coating speed varies depending on the wet layer thickness, and the drying capacity of facilities, but is commonly about 10 to about 1,000 m per minute, with 20 to 500 m per minute being preferred.

Further, in the case of additives that, although they do not get decomposed nor cause gel formation or aggregation by reacting immediately after being added to the above coating solution, but have characteristics of causing reaction or decomposition when the coating solution is left stagnating for a long duration, it is desirable to use the method of carrying out in-line mixing immediately before coating the coating solution. The words “immediately before coating” here means a time until coating of 1 second to about 10 minutes.

The aforesaid coating solution may be coated, employing a suitable method which is selected from methods known in the art. Preferably employed are, for example, a gravure coating method, a roll coating method, a rod bar coating method, an air knife coating method, a spray coating method, an extrusion coating method, a curtain coating method, or an extrusion coating method described in U.S. Pat. No. 2,681,294, which employs a hopper.

The ink absorbing layer of a recording sheet according to the present invention can be either a single layer or multiple layers, and in the case of a multiple layer structure, it is desirable, from the point of view of reducing the manufacturing cost, that all the layers are coated simultaneously.

Next, a description is given about the functional layer forming solution to be used for coating the overcoat layer. It is desirable to coat the functional layer forming solution for the overcoat layer in the same line as that of the coating of said porous layer after a water soluble coating solution is coated to form a ink absorbing layer having hydrophilic binder and fine particles on a support material, and after the water content of the coated film has become lower than the amount of void volume of the porous layer at the end point of drying process, that is, it is desirable to coat the overcoat layer in an on-line coating.

The words “void volume of the porous layer” in the present invention refer to the liquid transfer volume in a contact time of 2 seconds when the finally obtained recording sheet is measured according to the liquid absorption testing method (Bristow Method) stipulated in the J. TAPPI 51 standard for paper and cardboard.

The words “after the water content of the coated film becomes less than the void volume after drying” in the present invention broadly correspond to, in general, a region beyond the falling-rate drying zone in the drying area.

As the additives included in said solution for coating the overcoat layer, it is possible to use them for various types of compounds, when the compounds are added to said coating solution, in the case of chemical compounds that are likely to increase cracks at the time of drying, or that form aggregations, or that greatly decrease or increase the viscosity of the coating solution even if the chemical compound can be added to said coating solution for the ink absorbing layer, and also in the case effective effects can be hardly obtained due to reaction with water or other additives in the coated film when chemical compound is added to the coating solution. There are listed organic or inorganic acids of which the pH varies by the use of the addition agents for example, various alkaline additives, water-soluble salts of water-soluble polyvalent metal ions, various anionic, cationic, amphoteric or nonionic surfactant, anti-discoloring agents, cationic fixing agents, or cross-linking agents of hydrophilic binders.

Listed as acids which can be used to decrease the surface pH of the porous layer may be, for example, inorganic acids such as sulfuric acid, hydrochloric acid, nitric acid, phosphoric acid, as well as organic acids such as citric acid, formic acid, acetic acid, phthalic acid, succinic acid, oxalic acid, and polyacrylic acid. The pH of the solution is preferably 1 to 6, and more preferably 1 to 5. The final surface pH after pH adjustment is preferably 3 to 7 and specifically preferably 3.5 to 6.

Listed as alkalis which are used to increase the surface pH of the ink absorbing layer may be, for example, sodium hydroxide, potassium hydroxide, sodium carbonate, potassium carbonate, borax, sodium phosphate, calcium hydroxide, and organic amines. The pH of the solution including the alkalis is 8 to 14, is preferably 8 to 13 and specifically preferably 9 to 12.

The aforesaid pH regulating agents are most preferably employed when the pH of the coating solution for ink absorbing layer forming is different from the preferable pH of the ink jet recording medium.

The surface pH of the ink absorbing layer of the recording media varies depending on the types of ink. Generally, at a lower pH, water resistance of dyes is enhanced and bleeding of dyes is minimized. On the other hand, at a higher pH, lightfastness of dyes tends to be markedly improved. Considering that, an optimal pH is selected based on combinations with the used ink. The pH of the porous surface is preferably from 3 to 7, and is more preferably from 3.5 to 6.5. The layer surface pH, as described herein, refers to the value determined based on surface pH measurement method of paper, specified in J. TAPPI 49. In practice, 50 μl of pure water (having a pH of 6.2 to 7.3) is dripped onto the surface of a recording medium and the resulting pH is measured, employing a commercially available flat electrode.

It is desirable that the coating method according to the present invention is applied in the case of coating a liquid for the overcoat layer that includes a cross-linking agent of the hydrophilic binder as an additive on said porous ink absorption layer in an on-line coating.

The cross-linking agents described earlier can be used in the present invention.

In the present invention, one of the desirable forms is that the cross-linking agent of the hydrophilic binder is included beforehand in the water soluble coating solution that forms the ink absorbing layer, and in addition, a cross-linking agent is included in the functional layer forming solution for the overcoat layer, because it significantly increases the cross-linking effect of the hydrophilic layer and the effect of improving the ink absorption characteristics is large.

The cross-linking agent used at the time of coating the overcoat layer can be the same cross-linking agent that is included in the water soluble coating solution or can be different. The cross-linking agent in the overcoat layer is used at a ratio of 1% -100% by weight with respect to the hydrophilic binder, and desirably in the range of 5%-50% by weight. The particularly desirable cross-linking agents are said types of boric acids, zirconium salts, aluminum salts, or epoxy type cross-linking agents.

In the present invention, it is also desirable if the functional layer forming solution for coating the overcoat layer in an on-line coating includes image stabilizing agents (also referred to in the following as anti-discoloring agents).

In the ink jet recording medium according to the present invention, it is possible to use anti-discoloring agents known in the conventional ink jets. This anti-discoloring agent is one that prevents discoloration due to light illumination or the discoloration due to various types of oxidizing gases such as ozone, activated oxygen, NOx, SOx, etc. It is possible to use as such anti-discoloring agents, for example, antioxidants disclosed in Japanese Patent Application Tokkai syou Nos. 57-74192, 57-87989, and 60-72785, ultra violet ray absorbing agent disclosed in Japanese Patent Application Tokkai syou No. 57-74193, hydrazides disclosed in Japanese Patent Application Tokkai syou No. 61-154989, hindered amine system antioxidant disclosed in Japanese Patent Application Tokkai syou No. 61-146:591, nitrogenous multiple-element ring mercaptol system chemical compounds disclosed in Japanese Patent Application Tokkai syou No. 61-177279, thio-ether type antioxidants disclosed in Japanese Patent Application Tokkai hei Nos. 1-115677 and 1-36479, hindered phenol system antioxidants with specific structures that are disclosed in Japanese Patent Application Tokkai hei No. 1-36480, ascorbic acid types disclosed in Japanese Patent Application Tokkai hei Nos. 7-195824 and 8-150773, zinc sulfate disclosed in Japanese Patent Application Tokkai hei No. 7-149037, thiocyanate salts disclosed in Japanese Patent Application Tokkai hei No. 7-314882, thiouric derivatives disclosed in Japanese Patent Application Tokkai hei No. 7-314883, sugars disclosed in Japanese Patent Application Tokkai hei Nos. 7-276790 and 8-108617, phosphate type antioxidants disclosed in Japanese Patent Application Open Tokkai hei No. 8-118791, nitrous salts, sulfurous salts, thio-sulfates, etc., disclosed in Japanese Patent Application Tokkai hei No. 8-300807, and also hydroxylamine derivatives disclosed in Japanese Patent Application Tokkai hei No. 9-267544. In addition, even the polycondensations such as dicyandiamide and polyalkylanepolyamine disclosed in Japanese Patent Application Tokkai No. 2000-263928 are also some of the effective anti-discoloring agents for ink jets.

Although the above anti-discoloring agents can be added in the functional layer forming coating solution for forming the porous film, in the present invention, in order to prevent aggregation or the increase in cracks of the coating solution, overcoat layer coating method is preferable because it allows the addition of more amount of the additives.

The quantity of anti-discoloring agent to be added is roughly 0.01 g-5 g per 1 m² of the recording sheet, and preferably be in the range of 0.1 g -2 g. Although the discoloration prevention effect is large if the amount is large, there is a natural limitation due to the reduction of the void volume.

Functional layer forming solutions may include cationic polymers. Generally, cationic polymers act as fixing agents of dyes and enhance water resistance as well as minimize bleeding. Accordingly, it is preferable that the cationic polymers are previously incorporated in a coating solution for ink absorbing layer forming. However, when problems occur due to the addition of cationic polymers to the coating solution, the cationic polymers can be supplied, employing an overcoating method. For example, when the viscosity of a coating solution increases during storage through incorporation of cationic polymers, or when coloring properties are improved by allowing cationic polymers to form the specified distribution in the ink absorbing layer, it is preferable to supply the cationic polymers, employing the overcoating method. When the cationic polymers are supplied employing the overcoating method, the amount of cationic polymers is commonly in the range of 0.1 to 5 g per m² of the recording sheet.

It is preferable that a functional layer forming solution to be overcoated by on-line coating includes a water soluble polyvalent metal compound.

The water-soluble polyvalent metal compounds tend to coagulate in a coating solution including minute inorganic particles, whereby minute coating defects, as well as a decrease in glossiness, tend to occur. Therefore, it is particularly preferable to supply the water-soluble polyvalent compounds, employing an overcoating method.

Such polyvalent metallic compounds are, for example, sulfates, chlorides, nitrates and acetates of such as Mg²⁺, Ca²⁺, Zn²⁺, Zr²⁺, Ni²⁺and Al³⁺. Further, inorganic polymers of such as basic polyhydroxy aluminum and zirconium acetate are also listed as preferable examples of a water-soluble polyvalent metallic compound. Many of these water-soluble compounds are generally provided with functions of improving light fastness, bleeding resistance and water resistance. These water-soluble polyvalent metallic ions are employed in a range of approximately 0.05-20 mmol and preferably 0.1-10 mmol per 1 m² of the recording sheet.

Inclusion of surfactant in a solution with additives to be used for overcoating in the on-line coating is also preferable.

Surfactant are capable of controlling dot diameter during ink jet recording. Listed as such surfactant may be anionic, cationic, amphoteric, and nonionic surfactant. Further, surfactant may be employed in combination of at least two types. The added amount of surfactant is about 0.01 to 50 mg per m² of the recording media. When exceeding 50 mg, unevenness in mottled appearance tends to occur during ink jet recording.

The functional layer forming solution can include various types of additives other than the above. As such additives, a dye to adjust the image color of white background, a mildewproofing agent, a water-soluble polymer and a plasticizer (glycerin and diethylene glycol and the like) can be cited.

Each of the aforesaid addition agents may be employed individually or in combination of at least two types. Specifically, it is possible to employ an aqueous solution containing at least two anti-discoloring agents, a solution containing an anti-discoloring agent and a cross-linking agent, as well as a solution containing an anti-discoloring agent and a surfactant. In addition, it is possible to employ in combination cross-linking agents, water-soluble polyvalent compounds and anti-discoloring agents.

Employed as solvents of the aforesaid addition agents may preferably be water or solutions prepared by mixing water with water-compatible (or water-miscible) organic solvents, however it is particularly preferable to employ water. Further preferred are mixed solvents of water with water-compatible low boiling-point organic solvents (such as methanol, ethanol, i-propanol, n-propanol, acetone, and methyl ethyl ketone). When water and water-compatible organic solvents are employed in combination, it is preferable that the content ratio of water is at least 50 percent by weight under weight ratio.

Low boiling-point organic solvents, as described herein, refer to organic solvents which have a water solubility of at least 10 percent by weight at room temperature and have a boiling point of at most 120° C.

Further, from the viewpoint of obtaining uniform coatability, the surface tension of a functional layer forming solution, which are employed in the coating method of the present invention, is preferably from 200 to 600 μN/cm.

The words “after the water content of the coated film becomes less than the void volume after drying” in the present invention broadly correspond to, in general, a region beyond the falling-rate drying zone in the drying area. In the falling-rate drying zone, the phenomenon may occur that the evaporation of water content from the surface exceeds the movement of the water content of the coated film within the layer, and in general, the void formation starts after the substrate has entered the falling-rate drying zone and the water content evaporates further.

If the coating is made while the drying is insufficient and the water content of the coated film exceeds the void volume, aggregation can occur at the surface or the coating solution flows during the drying process thereby making it easy for non-uniformity to occur in the glossiness or in various ink jet recording characteristics.

Further, even when the water content of the coated film is less than the void volume, when drying and winding in the form of a roll is applied and then coating again, since the state of the hydrophilic binder of the film changes due to the passage of time, and manufacturing fluctuations can easily occur, it is necessary to apply the coating before winding in the form of a roll. The words “applying the functional layer forming solution in the on-line coating” in the present invention refer to applying before drying the film and winding it in the form of a roll.

The desirable timing of coating the functional layer forming solution is when the water soluble coating solution is coated, and the drying is conducted until the total quantity of the water content of the film and the solution becomes less than the void volume of the dried film, and the particularly desirable timing is when the drying has been conducted up to the point at which the water content of the film is substantially equivalent to that of the surrounding air.

The quantity of the coated functional layer forming solution changes with the timing of drying of the film as described above, and the total amount of the water content of the film and the solution is selected so that it is less than the void volume after drying. The void volume of the porous layer after drying has the same definition as the void volume at the end point of drying. Beyond the end point of drying, the void volume of the porous layer does not change.

In the case of a particularly preferable state of coating the solution when the drying has been done up to the point at which the water content of the film is substantially equivalent to that of the surrounding air, the feature is that the total amount of water content in the porous layer and the functional layer forming solution is 1.5 times or less than the void volume of the porous layer at the end point of drying, and more preferably in the range of 0.05-1.5 times the void volume. When less than 0.05 times the void volume, the coating of the solution can easily become non-uniform, and when more than 1.5 times, the liquid can flow and coating non-uniformity can occur easily. The preferable supply rate of the solution is 0.1-1.2 times the void volume. Here, the word “water” in water content refers to the liquid (water or its mixture) that evaporates due to drying of the film.

The coating of said functional layer forming solution on the porous film can be conducted as one coating or separate coatings of more than twice. In the latter case, at the time of each coating, it is necessary to coat so that the sum of the water content in the film and the volume of solution is lower than the void volume of the porous layer.

In the present invention, after the functional layer forming solution has been coated, it is possible to wind practically without drying. The words “practically without drying” refer to that the drying process is not always necessary when the sum of water content of the film and the volume of solution supply is less than about 30% of the void volume, although after said functional layer forming solution is coated on an ink absorbing layer normally it is desirable to dry it by passing it through a high temperature zone or by blowing air on it.

### EXAMPLES

In the following, although the present invention is described in terms of concrete examples of providing the functional layer of ink jet recording media using a coating apparatus according to the present invention, the present invention shall not be construed to be limited to these.

### Example 1

[Preparation of Substrate]

A substrate with a 4-layer structure was prepared by forming porous ink absorption layer as a constituent layer on a support material. To begin with, the following dispersion liquids for the constituent layers were prepared.

(Preparation of Silica Dispersion D1 and D2)

Silica dispersion B1 (pH =2.3, containing 1 weight % of ethanol) of 400 L containing 25% of gas phase silica (A 200, manufactured by Nippon Aerosil Co., Ltd.), having a mean primary particle diameter of approximately 0.012 μm and uniformly dispersed in advance, and 0.3% of water-soluble fluorescent whitening agent UVITEXNFW LIQUID (manufactured by Ciba Specialty Chemicals Corp.), were added into 110 L of aqueous solution C1 (pH 2.5, containing 2 g of defoaming agent SN381, manufactured by Sunnopco Co., Ltd.) containing 12% of cationic polymer P-1, 10% of n-propanol and 2% of ethanol, while stirring at 3000 rpm under room temperature. Next, into the resulting solution, 54 L of mixed aqueous solution Al (each 3 weight % concentration) of 1/1 (weight ratio) of boric acid and borax was gradually added while stirring.

Next, the solution was homogenized by use of a high-pressure homogenizer, manufactured by Sanwa Kogyo Co., Ltd., under a pressure of 3000 N/cm² and the total volume was made up to 630 L with pure water, resulting in preparation of nearly transparent silica dispersion D1.

Above-described silica dispersion B1 of 400 L was added into 120 L of aqueous solution C2 (pH =2.5), containing 12% of cationic polymer P-2, 10% of n-propanol and 2% of ethanol, while stirring at 3000 rpm under room. temperature, and then, into the resulting solution, 52 L of above-described mixed aqueous solution Al was added while stirring.

Next, the solution was homogenized by use of a high-pressure homogenizer, manufactured by Sanwa Kogyo Co., Ltd., under a pressure of 3000 N/cm² and the total volume was made up to 630 L with pure water, resulting in preparation of nearly transparent silica dispersion D2.

Above-described silica dispersions D1 and D2 were filtered by use of a TCP-30 type filter, manufactured by Advantech Toyo Co., Ltd., having a filtering precision of 30

(Preparation of Oil Dispersion)

Di-isodecyl phthalate of 20 kg and 20 kg of an anti-oxidant (AO-1) were dissolved with heating in 45 kg of ethyl acetate, and after the resulting solution was mixed with 210 L of a gelatin solution, containing 8 kg of acid processed gelatin, 2.9 kg of a cationic polymer P-1 and 10.5 kg of saponin at 55° C., to be emulsifying dispersed by use of a high-pressure homogenizer, and the total volume was made up to 300 L with pure water, resulting in preparation of an oil dispersion.

[Chem. 1]

Cationic Polymer P-1

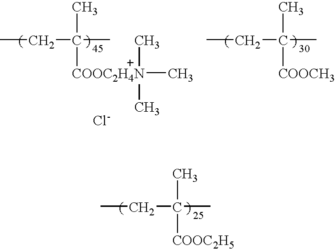

Cationic Polymer P-2

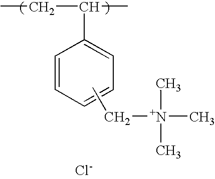

Anti-Oxidant (AO-1)

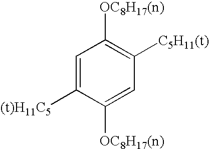

Coating solutions constituting ink absorbing layers were prepared. Each amount of addition is shown as the amount per 1 L of a coating solution. The symbol “%” in the examples represents percentage by mass if no explanation is added.

<First Layer Coating Solution: Lowermost Layer>

| | | |
|---|---|---|
| Silica dispersion D1 | 580 | ml |
| 10 percent aqueous polyvinyl alcohol (PVA203, | 5 | ml |
| manufactured by Kuraray Co.) solution | | |
| 6.5 percent aqueous polyvinyl alcohol (having an | 290 | ml |
| average degree of polymerization of 3,800 and a | | |
| saponification ratio of 88 percent) solution | | |
| Oil dispersion | 30 | ml |
| Latex dispersion (AE803, manufactured by Showa | 42 | ml |
| Kobunshi Co.) | | |
| Ethanol | 8.5 | ml |
| Pure water to make overall amount of | 1000 | ml |

<Second Layer Coating Solution>

| | | |
|---|---|---|
| Silica dispersion D1 | 600 | ml |
| 10 percent aqueous polyvinyl alcohol (PVA203, | 5 | ml |
| manufactured by Kuraray Co.) solution | | |
| 6.5 percent aqueous polyvinyl alcohol (having an | 270 | ml |
| average degree of polymerization of 3,800 and a | | |
| saponification ratio of 88 percent) solution | | |
| Oil dispersion | 20 | ml |
| Latex dispersion (AE803, manufactured by Showa | 22 | ml |
| Kobunshi Co.) | | |
| Ethanol | 8 | ml |
| Pure water to make overall amount of | 1000 | ml |

<Third Layer Coating Solution>

| | | |
|---|---|---|
| Silica dispersion D2 | 630 | ml |
| 10 percent aqueous polyvinyl alcohol (PVA203, | 5 | ml |
| manufactured by Kuraray Co.) solution | | |
| 6.5 percent aqueous polyvinyl alcohol, (having an | 270 | ml |
| average degree of polymerization of 3,800 and a | | |
| saponification ratio of 88 percent) solution | | |
| Oil dispersion | 10 | ml |
| Latex dispersion (AE803, manufactured by Showa | 5 | ml |
| Kobunshi Co.) | | |
| Ethanol | 3 | ml |
| Pure water to make overall amount of | 1000 | ml |

<Fourth Layer Coating Solution: Uppermost Layer>

| | | |
|---|---|---|
| Silica dispersion D2 | 660 | ml |
| 10 percent aqueous polyvinyl alcohol (PVA203, | 5 | ml |
| manufactured by Kuraray Co.) solution | | |
| 6.5 percent aqueous polyvinyl alcohol (having an | 250 | ml |
| average degree of polymerization of 3,800 and a | | |
| saponification ratio of 88 percent) solution | | |
| 4 percent aqueous betaine type surface active agent | 3 | ml |
| 25 percent aqueous saponin solution | 2 | ml |
| Ethanol | 3 | ml |
| Pure water to make overall amount of | 1000 | ml |

Subsequently, a substrate was prepared by simultaneously applying each of the aforesaid coating solutions at 40° C. onto a paper support material laminated with polyethylene on both sides, employing a slide bead type coating apparatus so as to achieve the wet layer thickness described below. The coating width was 1.0 m and coating rate was 200 m/min.

<Wet Layer Thickness>

First layer: 37 μm

Second Layer: 38 μm

Third layer: 38 μm

Fourth layer: 37 μm

After applying an ink adsorptive layer coating solution, the resulting coating passed through a 5° C. cooling zone for 15 seconds so as to decrease the layer surface temperature to 13° C. Thereafter, the coating was dried by passing through each of the several zones of a drying process in which air at the temperature, described below, was successively blown over the surface of the ink absorptive layer.

Incidentally, the total time of the drying process was set at 360 seconds. Of these, for 270 seconds after the start of drying, the average relative humidity of the blown air was set at less than or equal to 30 percent. After 270 seconds, a rehumidifying zone, having a relative humidity of 40 to. 60 percent was provided.

During drying, layer surface temperatures were measured. As a result, it was found that the constant-rate drying zone continued for 150 seconds after the start of drying and thereafter, the falling-rate drying zone started, and the drying end point (the position in which the layer surface temperature was equal to the temperature of the blown air) was located approximately 240 seconds after the start of drying.

(Coating Method 1)

Employed as an overcoating layer coating composition was a 0.2 percent aqueous dye solution. Viscosity and surface tension of the aforesaid coating solution, at room temperature, were 1.5 mPa·s and 60 to 70 mN/m, respectively. The aqueous dye solution shown below was used.

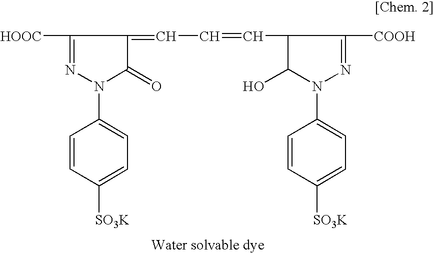

Prepared as a coating apparatus was an apparatus having a slot nozzle spray section shown in FIG. 5. In such a case, the opening end of the coating solution nozzle was a 120 μm long rectangular, while the pitch was 1,000 μn. The gas nozzle was shaped to be a 200 μm wide slit. During operation, the inner gas pressure was set at 20 kPa, while the air flow rate was set at 12 CMM/m, and the distance G between the coating solution discharge section and the recording medium was set at 20 mm. Five eddy current displacement sensors were embedded equally spaced in the tip of the slot nozzle within 1 meter width across the coating width direction including the center position so as to detect the position of the substrate thereby (the average measurement of the sensors aligned in the width direction was regarded as the position of the substrate).

The coating production line was constituted in the same manner as FIG. 8. However, only one slot nozzle spray apparatus was used, which was arranged in the position of 200 seconds after the start of the drying process of the aforesaid porous ink absorptive layer (in the falling-rate drying zone and prior to the drying end point).

As coating conditions, overcoating was carried out at a coating speed of 200 m/minute to achieve a wet layer thickness of 10 μm. The coating solution, which fell on the substrate, was in the form of droplets. The resulting uniformity of droplets across the coating width (1.0 m) was as follows.

| | |
|---|---|
| Variation of average droplet diameter | ±6.7 percent |
| Variation of length of drop | ±3.6 percent |
| Variation of spreading angle | ±3.3 percent |
| Variation of space density | ±4.0 percent |

However, the tension force between the rollers before and after the slot nozzle spray head was changed in five steps in the range of 19.6 N/m-490 N/m, and coating was done for 200 m each. By using coating solution spray, with respect to the tip section of the slot nozzle spray head, the displacement ‘a’ (mm) of the position of the surface of the substrate in the overcoat layer coating section changed as shown in Table 1 for each coating, depending on the adjustment of the tension force between the rollers, in the uncoated state and the coated state.

Further, the amounts of displacements of the position of the substrate in the uncoated state and the coated state were measured for each coating using a displacement sensor, and the respective values were obtained as the average values of the absolute values of the displacement from the records taken on a continuous basis.

After drying, the variations in the density of dye on the surface of the ink jet recording media after the respective coating and drying, and Table 1 summarizes the width of these variations. After coating of 150 m with the rollers respectively, the sample that has been coated for the full width is scanned in the full width direction using a densitometer thus obtaining the reflection density, and the absolute value of the difference between the maximum density and the minimum density is expressed as a percentage relative to the average density.

The maximum value of the respective variation was obtained and is indicated in Table 1, as well as examining visually each coating.

TABLE 1

| Displacement | Density | |
|---|---|---|
| (mm) | variation | |
| 15 | 27.0% | Comparison example |
| 10 | 13.5% | Comparison example |
| 5 | 4.8% | Example |
| 2 | 3.1% | Example |
| 1 | 1.8% | Example |

The results are less than or equal to 5 mm which is a displacement of within 0.5% with respect to the coating width, and is uniform to the extent that almost no density variation can be noticed by the visual inspection, and also it can be confirmed also from the results of Table 1 showing that the density variation is within 5% and the coating unevenness is small.

### Example 2

The same apparatus as that of the Example 1 was used as the coating apparatus.

However, at the time of coating the dye solution using said slot nozzle spray apparatus, this time, the tension force applied to the substrate in the coating section was varied in five steps as shown in Table 2 in the range of 19.6 N/m-294 N/m by adjusting the position of the rollers before and after the coating section. For each coating, similar to that described above, the results of measuring the variations in the dye density are shown in Table 2.

TABLE 2

| Tension force | Density | | | |
|---|---|---|---|---|
| (N/m) | variation | Displacement | | |
| 19.6 | 18.0% | 15 | mm | Comparison example |
| 49.0 | 11.0% | 10 | mm | Comparison example |
| 98.1 | 4.6% | 5 | mm | Example |
| 196 | 3.8% | 3 | mm | Example |
| 294 | 2.2% | 2 | mm | Example |

When the tension force is larger than 98.0 N/m, the density variations are less than 5% and even during a visual inspection almost no unevenness was observed.

### Example 3

A coating apparatus similar to that in Example 1 was used, excepting that slot nozzle spray apparatus used was one having a backing roller (embracing angle θ=5°) as shown in FIG. 12. The backing roller used had a roller diameter of 200 mm, and the roller surface material was stainless steel. The tension force between the rollers was adjusted, the displacement of the substrate ‘a’ in the uncoated state (spraying) and during coating (spraying) was changed to be at 5 points in the range 20 mm-1 mm and coating was carried out under the respective conditions. Visual examinations were done for unevenness for each coating.

A mark ‘A’ in this table indicates that no unevenness was visible and the mark ‘B’ indicates that unevenness is slightly visible and the mark ‘C’ indicates that unevenness is fully visible.

TABLE 3

| Displacement | Density | |
|---|---|---|
| (mm) | variation | |
| 20 | C | Comparison example |
| 10 | C | Comparison example |
| 5 | B | Comparison example |
| 2 | A | Example |
| 1 | A | Example |

No unevenness was observed when the displacement ‘a’ was 2 mm or less.

### Example 4

Similar to Example 3, the coatings were made using a slot nozzle spray apparatus with a backing roller as shown in FIG. 12. However, the backing roller having a stainless steel surface used in Example 3 were also used. Further, by adjusting the positions of the front and rear rollers the tension force applied to the substrate was made equal to 78.5 N/m, however, the embracing angle of the substrate (θ in FIG. 12) was changed as shown in Table 4 by changing the positions of the rollers, and coating was done on the substrate by spraying under each of these conditions. Unevenness was inspected visually for the samples obtained by change in the embracing angle.

TABLE 4

| Roller | Embracing | Density | Displace- | |
|---|---|---|---|---|
| diameter | angle | variation | ment | |
| 200 mm | 0° | 11.0% | 7 mm | Comparison example |
| 200 mm | 5° | 7.0% | 1 mm | Example |
| 200 mm | 30° | 3.8% | 0 mm | Example |
| 200 mm | 60° | 3.3% | 0 mm | Example |
| 200 mm | 90° | 2.3% | 0 mm | Example |
| 200 mm | 180° | 1.1% | 0 mm | Example |

It is clear that there is an effect on the density variations even when the tensile force of the substrate is weak if the embracing angle of the substrate around the backing roller is changed.

### Example 5

The coating was done in a manner similar to that used in said Example 4 but with a backing roller diameter of 100 mm, however similar results were obtained.

### Example 6

The test of Example 4 was carried out with the diameter of the backing roller being the same but the suction function being provided and further being rotated in synchronism with the conveyance of the substrate, the coating unevenness was examined visually while changing the embracing angle and the results are shown in Table 5, and the respective density variations were measured using a densitometer. As the backing roller with suction function, used was a 200 mm diameter backing roller provided with suction means for sucking air at the porous surface of the backing roller from the inside. Specifically, used was a backing roller made of sintered metal having fine holes of 50 μm-200 μm diameter on the surface with an opening area ratio of 40%. The suction force was adjusted to be 4.41 Pa.

TABLE 5

| Roller | Embracing | Density | | |
|---|---|---|---|---|
| diameter | angle | variation | Displacement | |
| 200 mm | 0° | 8.2% | 3 mm | Example |
| 200 mm | 5° | 5.2% | 0 mm | Example |
| 200 mm | 30° | 3.5% | 0 mm | Example |
| 200 mm | 60° | 3.0% | 0 mm | Example |
| 200 mm | 90° | 2.1% | 0 mm | Example |
| 200 mm | 180° | 1.0% | 0 mm | Example |

By using a backing roller with suction function, it is clear that the density variations are suppressed compared to the Example 5. In addition, the variations become smaller as the embracing angle becomes larger.

Regarding to the backing roller with a suction function and the table with a suction function; an evaluation was made in the cases of being rotated and not being rotated with synchronism and the following results has been obtained.

TABLE 6

| Shape in contact with | | |
|---|---|---|
| the back surface of | | Abrasion |
| the substrate | Drive | scratches |
| Suction roller | Present | N |
| | Absent | P |
| Suction table | Present | N |
| | Absent | P |

Abrasion scratches (Visual evaluation)
N: Not present
P: Present

### Example 7

[Preparation of substrate]

Similar to Example 1, ink jet recording sheet substrate was prepared by simultaneously coating the multiple layers one upon the other to form a 4-layer ink absorption layer on a paper support material covered with polyethylene by using a slide bead type coating apparatus. The width of coating was 1.0 m, the coating speed was 200 m/min, and a roller of 1000 m length was coated.

Next, a 4% aqueous solution of boric acid was used as the coating solution for overcoat layer. The viscosity of this coating solution was 1.5 mPa·s at room temperature and the surface tensile force 60-70 mN/m.

Similar to Example 3, the coatings were made using a slot nozzle spray apparatus with a backing roller as shown in FIG. 12. The opening end of the coating solution nozzle at this time had a square shape with the side length being 120 μm as shown in FIG. 5, and the pitch was 1000 μm. The gas nozzles were slit-shaped of 200 μm width. The internal gas pressure at this time was 20 kPa and the air flow rate was set at 12 CMM/m, and the distance G between the coating solution discharging section and the recording medium was set at 20 mm.

However, a backing roller having a stainless steel surface used in Example 3 was also used as a backing roller of the slot nozzle spray apparatus. Further, by adjusting the positions of the front and rear rollers the tension force applied to the substrate was made equal to 294 N/m, however, the embracing angle of the substrate (θ in FIG. 12) was set at 90°, and coating was conducted on the substrate by spraying.

Further, regarding the displacement of the substrate in the uncoated state and during coating, the measurement was continued during coating, and was found to be less than 2 mm over all processes of coating.

The coated surfaces were examined by visual inspection but no coating unevenness could be detected in the coating surfaces, and the coating surfaces had uniform finish.

### Example 8

Using a coating method described in Example 7, the coating was done in a similar manner excepting that the 4% boric acid solution was replaced by an aqueous solution of basic aluminum chloride. When observed visually, the finish on the coated surface was uniform without any unevenness similar to that in Example 7.

According to the present invention, it is possible, for example, at the time of obtaining ink jet recording media by additionally coating a functional layer that includes additives on an object to be coated (substrate) that has an ink absorbing layer, etc., coated on a support material, to coat the functional layer efficiently at a high speed and in a stable manner without generating coating defects (liquid splashes, mottle, streaks, etc.,), and also, without causing the problems of aggregation or precipitation, etc., due to contact between the liquids.

What is claimed is:

1. A spray coating apparatus comprising:
a conveying device to convey a substrate to be coated in a conveyance direction;
a spray head disposed to extend in a direction crossing the conveyance direction to coat a coating solution on the substrate;
a tensioning device to provide a predetermined degree of tension to the substrate in a coating portion of the spray head;
wherein the tensioning device maintains a variation of average positions of a surface of the substrate in the coating portion from a tip of the spray head between prior coating and during coating to be within 0.5% width of the substrate perpendicular to the conveyance direction.

2. The spray coating device of claim 1,
wherein the predetermined degree of tension provided by the tensioning device is within a range from 98.0 N/m to 980 N/m.

3. The spray coating apparatus of claim 1,
wherein the tensioning device maintains the variation to be 2 mm or less.

4. The spray coating apparatus of claim 1, further comprising:
a supporting member to support the substrate while the supporting member is in contact with an opposite side surface of a surface of the substrate on which a coating solution from the spray head is coated.

5. The spray coating apparatus of claim 4,
wherein the supporting member is a backing roller, and a bracing angle of the substrate in the coating portion around the roller is within a range from 5 to 180 degrees.

6. The spray coating device of claim 4,
wherein the supporting member has a suction function.

7. The spray coating apparatus of claim 4,
wherein the supporting member is driven to rotate synchronizing with a conveyance of the substrate.

8. The spray coating apparatus of claim 1,
wherein the substrate is composed of a support material and an ink absorbing layer coated on the support material, and coating of the ink absorbing layer and coating of an overcoat layer are carried out successively in a same line.

9. The spray coating apparatus of claim 1,
wherein a coating speed of spray coating on the, substrate is within a range from 50 m/min to 500 m/min.

10. A spray coating method comprising steps of:
conveying a substrate to be coated in a conveyance direction;
coating a coating solution on the substrate by a spray head disposed to extend in a direction crossing the conveyance direction;
providing a predetermined degree of tension to the substrate in a coating portion of the spray head;
wherein a variation of average positions of a surface of the substrate in the coating portion from a tip of the spray head between prior coating and during coating is maintained to be within 0.5% width of the substrate perpendicular to the conveyance direction in the providing step of providing the tension.

11. The spray coating method of claim 10,
wherein the predetermined degree of tension is within a range from 98.0 N/m to 980 N/m.

12. The spray coating method of claim 10,
wherein the variation is maintained to be 2 mm or less in the providing step of providing the tension.

13. The spray coating method of claim 10, further comprising:
a step of supporting the substrate by a supporting member which is positioned to be in contact with an opposite side surface of a surface of the substrate on which a coating solution from the spray head is coated.

14. The spray coating method of claim 13,
wherein the supporting member is a backing roller, and a bracing angle of the substrate in the coating portion around the roller is within a range from 5 to 180 degrees.

15. The spray coating method of claim 13,
wherein the supporting member has a suction function.

16. The spray coating method of claim 13,
wherein the supporting member is driven to rotate synchronizing with a conveyance of the substrate.

17. The spray coating method of claim 10,
wherein the substrate is composed of a support material and an ink absorbing layer coated on the support material, and coating of the ink absorbing layer and coating of an overcoat layer are carried out successively in a same line.

18. The spray coating method of claim 10,
wherein a coating speed of spray coating on the substrate is within a range from 50 m/min to 500 m/min.
